(19) United States
(12) Patent Application Publication
(10) Pub. No.: US 2010/0173042 A1
(43) Pub. Date: Jul. 8, 2010

(54) Chocolate extract, process of making, and uses thereof

(75) Inventors: Andrew McShea, Kingston, WA (US); Andrew Mark Morotti, Seattle, WA (US)

Correspondence Address: Michael D. Vrbanac, 17916 Normandy Terrace SW, Seattle, WA, 98166, US

(73) Assignees: Andrew McShea; Andrew Mark Morotti

(21) Appl. No.: 12/653,594

(22) Filed: Dec. 14, 2009

Related U.S. Application Data
(60) Provisional application No. 61/201,571, filed on Dec. 12, 2008.

(51) Int. Cl. A23G 1/32; A23G 1/56; A23L 1/28

(52) U.S. Cl. 426/2; 426/431; 426/430; 426/655; 426/385

(57) ABSTRACT

Disclosed herein are a chocolate extract and a process of making the extract. The process comprises mixing a chocolate source with a water miscible solution. The chocolate source and water miscible solution are at a temperature where the chocolate source is in a liquid state during mixing. The water miscible solution and the chocolate form a mixture of a water miscible phase, an oil phase, and a solid particle phase. The mixing allows the water miscible components to migrate into the water miscible phase. The mixture is separated to recover the water phase from the oil phase and the solid particle phase. This water miscible phase is the extract of chocolate.

### CROSS-REFERENCE TO RELATED APPLICATIONS

This patent application claims priority to U.S. Patent Application No. 61/201,571, filed Dec. 12, 2008, of which application is hereby incorporated by reference in its entirety for all purposes.

### TECHNICAL FIELD

The disclosure herein relates to an extract of chocolate, a process of making the extract, and uses of the extract in comestible products including low calorie drinks and energy drinks as well as use to increase uptake of orally administered drugs. The extract is obtained from refined chocolate. The extraction process mixes chocolate with water, or a water-based solution, to form a mixture thereof, followed by separation and recovery of the water phase from the mixture to provide the extract of chocolate.

### BACKGROUND

The seeds of Theobroma cacao, or simply cacao, are the basic raw ingredient of cocoa powder, chocolate, and cocoa butter. Manufacturers of these products use old and well-known processes, and these products are commonly combined with other ingredients to produce the plethora of commercially available products. For example, cocoa drinks generally contain cocoa powder in combination with milk, sugar, and flavorings. Cocoa drinks are relatively rich in calories and are composed of an emulsion/colloidal suspension of milk, cocoa fats, and cocoa solids. The primary component of cocoa drinks, the cocoa powder, is made by hydraulically pressing processed cacao-bean liquor, or cocoa nibs, to achieve partial separation of the fat from the solids. The pressing process releases and removes the fat while yielding a compressed cake, which consists of fat-depleted cocoa solids. The compressed cake is broken apart to provide cocoa powder.

Conventional cocoa powders typically contain 8-14% residual fat and tend to dissolve poorly in water. To improve dissolution, milk and/or other emulsifiers are frequently added to make the resulting beverage more uniform in look, texture, and taste. Sugar, vanilla, and other ingredients are also commonly added to provide less bitter flavor characteristics. One problem with these added ingredients, however, is that they significantly increase the caloric content of the cocoa drink, a problem shared by refined chocolate. The consumption of said comestibles is a significant source of calories in the form of fat and refined sugar. Often, milk fat and other vegetable fats are added to cocoa drinks as well. Over consumption of fat and sugar can lead to numerous problems including obesity and diabetes. These problems may overshadow the purported health benefits cacao-based products.

Considering the beneficial characteristics of cacao-based products, studies have purported to show that these products are rich in polyphenol antioxidants. The presence of polyphenol antioxidants, such as epicatechin and procyanidin, has been touted as beneficial for human health, based on the observations of lowered blood pressure, increased microvasculature circulation, and reductions in a variety of inflammatory processes. Whilst there is clinically meaningful data to suggest that these effects can be measured and that the effects are clinically significant, the physiological effects from the currently available products have not yet been proven to be measurably profound. (Adamson G E, Lazarus S A, Mitchell A E, Prior R L, Cao G, Jacobs P H, Kremers B G, Hammerstone J F, Rucker R B, Ritter K A, Schmitz H H. HPLC method for the quantification of procyanidins in cocoa and chocolate samples and correlation to total antioxidant capacity. J Agric Food Chem. 1999 October; 47(10):4184-8. Arteel G E, Sies H. Protection against peroxynitrite by cocoa polyphenol oligomers. FEBS Lett. 1999 Nov. 26; 462(1-2):167-70. Engler, M. B., Engler, M. M., Chen, C. Y., Malloy, M. J., Browne, A., Chiu, E., Kwak, H K, Milbury, P., Paul S M, Blumberg, J. Mietus-Snyder, M. Flavonoid-rich dark chocolate improves endothelial function and increases plasma epicatechin concentrations in healthy adults. Journal of the American College of Nutrition 23(3), 197-204. Engler, M. B., Engler, M. M. (2004) The vasculoprotective effects of flavonoid-rich cocoa and chocolate. Nutrition Research, 24(9): 695-706. Engler, M. B., Engler, M. M., The emerging role of flavonoid-rich cocoa and chocolate in cardiovascular health and disease. Nutrition Reviews 2006 March; 64(3); 109-18. Fisher N D et al. Flavanol-rich cocoa induces nitric oxide-dependent vasodilation in healthy humans. J Hypertens 2003 21:2281-6. Fisher N D L, Hughes M, Gerhard-Herman M, Hollenberg N K. Flavanol-rich cocoa induces nitric oxide-dependent vasodilation in healthy humans. J Hypertens 2003; 21:2281-6. Grassi D, Lippi C, Necozione S, Desideri G, Fern C. Short-term administration of dark chocolate is followed by a significant increase in insulin sensitivity and a decrease in blood pressure in healthy persons. Am J Clin Nutr 2004; 81:611-4. Grassi D, Necozione S, Lippi C, Croce G, Valeri L, Pasqualetti P, Desideri G, Blumberg J B, Fern C. Cocoa reduces blood pressure and insulin resistance and improves endothelium-dependent vasodilation in hypertensives. Hypertension 2005 August; 46(2):398-405. Heiss C, Dejam A, Kleinbongard P, Schewe T, Sies H, Kelm M. Vascular effects of cocoa rich in flavan-3-ols. JAMA 2003; 290:1030-1. Heiss C, et al. Vascular effects of cocoa rich in flavan-3-ols. JAMA 2003 290:1030-1. Hertog M G, Feskens E J, Hollman P C, Katan M B, Kromhout D. Dietary antioxidant flavonoids and risk of coronary heart disease: the Zutphen Elderly Study. Lancet 1993; 342:1007-1011. Hollenberg N, Martinez G, McCullough M, et al. Aging, acculturation, salt intake, and hypertension in the Kuna of Panama. Hypertension 1997; 29:171-6. Holt R R, Lazarus S A, Sullards M C, et al. Procyanidin dimmer B2 (epicatechin-[4beta-8]-epicatechin) in human plasma after the consumption of a flavanol-rich cocoa. Am J Clin Nutr 2002; 76:798-804. Hurst W J, Glinski J A, Miller K B, Apgar J, Davey M H, Stuart D A. Survey of the trans-resveratrol and trans-piceid content of cocoa-containing and chocolate products. J Agric Food Chem. 2008 September 24; 56(18):8374-8. Kondo K, Hirano R, Matsumoto A, Igarashi O, Itakura H. (1996) Inhibition of LDL oxidation by cocoa. Lancet 348, 1514. Kurosawa T, Itoh F, Nozaki A, Nakano Y, Katsuda S, Osakabe N, Tsubone H, Kondo K, Itakura H. Suppressive effect of cocoa powder on atherosclerosis in Kurosawa and Kusanagi-hypercholesterolemic rabbits. J Atheroscler Thromb 2005; 12(1):20-8. Murphy K J, Chronopoulos A K, Singh I, et al. Dietary flavanols and procyanidin oligomers from cocoa (Theobroma cacao) inhibit platelet function. Am J Clin Nutr 2003; 77:1466-73. Osakabe N, Baba S, Yasuda A, Iwamoto T, Kamiyama M, Takizawa T, Itakura H, Kondo K. Daily cocoa intake reduces the susceptibility of low density lipoprotein to oxidation as demonstrated in healthy human volunteers. Free Radic Res 2001; 34:93-99. Osakabe N, et al. Catechins and their oligomers linked by C4-C8 bonds are major cacao polyphenols and protect low-density lipoprotein from oxidation in vitro. Exp Biol Med 2002 227:51-6. Pearson D, Paglieroni T, Rein D, et al. The effects of flavanol-rich cocoa and aspirin on ex vivo platelet function. Thromb Res 2002; 106:191-97. Rein D, Paglieroni T G, Wun T, et al. Cocoa inhibits platelet activation and function. Am J Clin Nutr 2000; 72:30-35. Richelle M, Tavazzi I, Enslen M, Offord E A. Plasma kinetics in man of epicatechin from black chocolate. Eur J Clin Nutr. 1999 January; 53(1):22-6. Sabongi C, Suzuki N, Sakane T. Polyphenols in chocolate, which have antioxidant activity, modulate immune functions in humans in vitro. Cell Immunol 1997; 177:129-36. Schewe T, Sadik C, Klotz L, Yoshimoto T, Kuhn H, Sies H. Polyphenols of cocoa: Inhibition of mammalian 15-lipoxygenase. Biol Chem 2001 December; 382:1687-96. Schramm D D, Karim M, Schrader H R, Holt R R, Kirkpatrick N J, Polagruto J A, Ensunsa J L, Schmitz H H, Keen C L. Food effects on the absorption and pharmacokinetics of cocoa flavanols. Life Sciences 2003; 73:857-869. Schramm D D, Wang J F, Holt R R, et al. Chocolate procyanidins decrease the leukotriene-prostacyclin ratio in humans and human aortic endothelial cells. Am J Clin Nutr 2001; 73:36-40. Schroeter H, Heiss C, Balzer J, Kleinbongard P, Keen C L, Hollenberg N K, Sies H, Kwik-Uribe C, Schmitz H H, Kelm M. (−)-Epicatechin mediates beneficial effects of flavanol-rich cocoa on vascular function in humans. Proc Natl Acad Sci USA. 2006 Jan. 24; 103(4):1024-9. Serafini M, Bugianesi R, Maiani G, Valtuena S, De Santis S, Crozier A. Plasma antioxidants from chocolate. Nature 2003 Aug. 28; 424(6952):1013. Sies H, Schewe T, Heiss C, Kelm M. Cocoa polyphenols and inflammatory mediators. Am J Clin Nutr 2005 January; 81(1 Suppl):304S-312S. Steinberg F M, Bearden M M, Keen C L. Cocoa and chocolate flavonoids: implications for cardiovascular health. J Am Diet Assoc 2003 February; 103(2):215-23. Steffen Y, et al. Epicatechin protects endothelial cells against oxidized LDL, and maintains NO synthase. Biochem Biophys Res Commun 2005 331:1277-83. Taubert D, Berkels R, Roesen R, Klaus W. Chocolate and blood pressure in elderly individuals with isolated systolic hypertension. JAMA 2003; 290:1029-30. Vlachopoulos C, Aznaouridis K, Alexopoulos N, Economou E, Andreadou I, Stefanadis C. Effect of dark chocolate on arterial function in healthy individuals. Am J Hypertens 2005 June; 18(6):785-91. Vita J A. Polyphenols and cardiovascular disease: effects on endothelial and platelet function. Am J Clin Nutr 2005 81:292 S-7S. Wan Y, et al. Effects of cocoa powder and dark chocolate on LDL oxidative susceptibility and prostaglandin concentrations in humans. Am J Clin Nutr 2001 74:596-602. Wan Y, Vinson J A, Etherton T D, Proch J, Lazarus S, Kris-Etherton P. Effects of cocoa powder and dark chocolate on LDL oxidative susceptibility and prostaglandin concentrations in humans. Am J Clin Nutr 2001; 74:596-602. Wang J F, et al. A dose-response effect from chocolate consumption on plasma epicatechin and oxidative damage. J Nutr 2000 130:2115 S-9S. Wiswedel I, Hirsch D, Kropf S, Gruening M, Pfister E, Schewe T, Sies H. Flavanol-rich cocoa drink lowers plasma F(2)-isoprostane concentrations in humans. Free Radic Biol Med 2004 Aug. 1; 37(3):411-21.)

Thus, another problem with the conventional cacao-based products on the market is that the purported physiological effects are barely perceptible. Put simply, drinking or eating chocolate in any of the current forms does not seem to do a great deal apart from satisfy appetite and satiate a desire to consume something that tastes good.

Yet, legends persist about cacao-based products being addictive or having more potent effects on metabolism. For example, Cortez described these effects in 1519, during his visit to the Aztec Empire as “The divine drink, which builds up resistance & fights fatigue. A cup of this precious drink permits man to walk for a whole day without food.” Indeed, this legendary drink derived from the cocoa bean was claimed to have aphrodisiac powers and provide strength. These claimed benefits are appealing; however, one problem is that no definitive studies have proven that these benefits are profound in cocoa and chocolate products.

Moreover, another problem is that studies have not definitively shown what components of the cocoa solids are of true nutritional value, or possibly of a therapeutic value, to the consumer. The physiological benefits of consuming said comestibles are marginal. Indeed, the purported clinical effects are barely perceptible, despite physiologically significant concentrations of active biomolecules being present. This low perceptibility suggests that the bioavailability of chemically active substances in cocoa-based products and chocolate is quite low.

Literature exists that describes potentially bioactive moieties in chocolate and cocoa powder. However the exact identity of the active species is still, to a large extent a guess, since the pharmacology and drug interactions of these biomolecules are incompletely described. Indeed, chocolate is incredibly complex, and a great deal of information in terms of correlating presence of certain species and physiological effect remains to be determined. An overview of some of the components in cocoa nibs and the volatiles that impart flavor from cocoa compositions is described by Stark et al., Ducki et al., and Frauendorfer et al. (Stark T, Bareuther S, Hofmann T. Molecular definition of the taste of roasted cocoa nibs (Theobroma cacao) by means of quantitative studies and sensory experiments. J Agric Food Chem. 2006 Jul. 26; 54(15):5530-9. Ducki S, Miralles-Garcia J, Zumbé A, Tornero A, Storey D M. Evaluation of solid-phase micro-extraction coupled to gas chromatography-mass spectrometry for the headspace analysis of volatile compounds in cocoa products. 2008 Feb. 15; 74(5):1166-74. Frauendorfer F, Schieberle P. Changes in key aroma compounds of Criollo cocoa beans during roasting. J Agric Food Chem. 2008 Nov. 12; 56(21):10244-51. Frauendorfer F, Schieberle P. Identification of the key aroma compounds in cocoa powder based on molecular sensory correlations. J Agric Food Chem. 2006 Jul. 26; 54(15):5521-9.)

The flavor of chocolate changes radically from cocoa nib to cocoa powder to “conched” chocolate. The chemistry of nibs, cocoa powder and chocolate changes as well especially during roasting and conching. It is also possible that chemical changes occur during the milling, refining and emulsification stages. Ducki et al describe the chemical changes that occur in the profile of the volatiles that off-gas during the conching process and the cocoa nib roasting process is known to result in numerous Maillard reaction products (Stark T, Bareuther S, Hofmann T. Molecular definition of the taste of roasted cocoa nibs (Theobroma cacao) by means of quantitative studies and sensory experiments. J Agric Food Chem. 2006 Jul. 26; 54(15):5530-9. Frauendorfer F, Schieberle P. Changes in key aroma compounds of Criollo cocoa beans during roasting. J Agric Food Chem. 2008 Nov. 12; 56(21):10244-51. Frauendorfer F, Schieberle P. Identification of the key aroma compounds in cocoa powder based on molecular sensory correlations. J Agric Food Chem. 2006 Jul. 26; 54(15):5521-9.)

One would therefore expect the choice of starting material to affect the flavor of the product, the chemical composition and the bioactivity of the extract. The modest bioactivity of cocoa drinks or dark chocolate has been attributed to a variety of molecular species including epicatechin (Schroeter H, Heiss C, Balzer J, Kleinbongard P, Keen C L, Hollenberg N K, Sies H, Kwik-Uribe C, Schmitz H H, Kelm M. (−)-Epicatechin mediates beneficial effects of flavanol-rich cocoa on vascular function in humans. Proc Natl Acad Sci USA. 2006 Jan. 24; 103(4):1024-9. Richelle M, Tavazzi I, Enslen M, Offord E A. Plasma kinetics in man of epicatechin from black chocolate. Eur J Clin Nutr. 1999 January; 53(1):22-6), procyanidin(s) (Adamson G E, Lazarus S A, Mitchell A E, Prior R L, Cao G, Jacobs P H, Kremers B G, Hammerstone J F, Rucker R B, Ritter K A, Schmitz H H. HPLC method for the quantification of procyanidins in cocoa and chocolate samples and correlation to total antioxidant capacity. J Agric Food Chem. 1999 October; 47(10):4184-8. Arteel G E, Sies H. Protection against peroxynitrite by cocoa polyphenol oligomers. FEBS Lett. 1999 Nov. 26; 462(1-2):167-70. Fisher N D et al. Flavanol-rich cocoa induces nitric oxide-dependent vasodilation in healthy humans. J Hypertens 2003 21:2281-6. Fisher N D L, Hughes M, Gerhard-Herman M, Hollenberg N K. Flavanol-rich cocoa induces nitric oxide-dependent vasodilation in healthy humans. J Hypertens 2003; 21:2281-6), caffeine, theobromine (Richelle M, Tavazzi I, Enslen M, Offord E A. Plasma kinetics in man of epicatechin from black chocolate. Eur J Clin Nutr. 1999 January; 53(1):22-6) and resveratrol (Hurst W J, Glinski J A, Miller K B, Apgar J, Davey M H, Stuart D A. Survey of the trans-resveratrol and trans-piceid content of cocoa-containing and chocolate products. J Agric Food Chem. 2008 Sep. 24; 56(18):8374-8). However the degree to which the individual compounds mimic the effect of an extract across a spectrum of physiological responses is not clear, suggesting that the identification of active moieties or formulation after purification/isolated synthesis is incomplete.

The literature describes some significant clinical effects and the chemistry of purified compounds, but these effects seem to lack potency in chocolate and other cocoa-based products. Thus, there appears to be inconsistency with the formulation of current products and the claimed benefits of consuming such products. In addition, given the purported presence of these active moieties in cocoa-based products, chocolate bars, and cocoa drinks would be expected to resemble a metabolically more potent food like coffee or wine; however, such is not the case.

Another problem is that although literature purports to show that there are, or may be, beneficial attributes of consuming specific polyphenols individually, the commercial market is devoid of such products, suggesting that consumption of isolated specific polyphenols may not provide the purported benefits, and/or the isolated specific polyphenols might not work in commercial chocolate and/or cocoa-based products. In other studies to ascertain why chocolate may be “addictive” a biochemical study showed that chocolate was shown to contain small amounts of anandamide, a molecule thought to act on cannabinoid receptors and a candidate molecule for mediating physiological changes after the consumption of chocolate. However, the original observation of anandamide activity in chocolate (Di Tomaso E, Beltramo M, Piomelli D. Brain cannabinoids in chocolate. Nature. 1996 Aug. 22; 382(6593):677-8) was criticized because the dose was too small and the uptake of anandamide from the gut in animal studies was negligible (Di Marzo V, Sepe N, De Petrocellis L, Berger A, Crozier G, Fride E, Mechoulam R. Trick or treat from food endocannabinoids? Nature. 1996 Aug. 22; 382(6593):677-8.)

Literature regarding preparation of cacao-based drinks describes processes that start with cocoa powder, not refined chocolate. For example, US 2006/0034999 A1 discloses a method of producing from cacao nibs a chocolate drink containing cacao fat/oil but without the insoluble solids from the cacao nib. In the method, ground cacao nibs are extracted with water at a temperature sufficiently high to melt the cacao fat/oil. The extraction temperature is 28 to 95 degrees Celsius but is more preferably 60 to 95 degrees Celsius; higher temperatures are preferable to improve extraction efficiency. The extraction time is set according to the temperature and can range from 5 minutes to 24 hours. The insoluble cacao nib solids are removed using common liquid-solid separation equipment (strainer, cyclone, centrifuge, filtration) at a temperature where the cacao fat/oil remains liquid. The water and cacao fat/oil phase is recovered from the solid phase. The recovered liquid is homogenized and finished by adding other ingredients. In example 1, a three-phase separation is performed to obtain a liquid phase having a low amount of cacao fat/oil as a control to demonstrate that the cacao fat/oil is necessary to provide a satisfactory drink.

As another example, U.S. Pat. No. 5,338,554 discloses a process for producing a soluble cocoa product that has reduced fat and theobromine content. The process comprises: (a) subjecting roasted cocoa powder to extraction with ethanol in the temperature range of between 60 and 80 degrees Celsius so as to produce an extract containing fat and theobromine and a cocoa powder residue with reduced fat and theobromine contents; (b) separating the extract and the cocoa powder residue; (c) subjecting the cocoa powder residue to extraction with ethanol in the temperature range of between 60 and 80 degrees Celsius so as to produce a further extract containing fat and theobromine and a cocoa powder residue with further reduced fat and theobromine contents; (d) separating the further extract and the cocoa powder residue; (e) mixing the cocoa powder residue from step (d) with water and agitating the mixture in the temperature range of between 60 and 95 degrees Celsius to produce an aqueous extract and cocoa powder residue; (f) separating the aqueous extract and the cocoa powder residue; (g) mixing the cocoa powder residue from step (f) with water and agitating the mixture in the temperature range of between 60 degrees Celsius and 95 degrees Celsius to produce a further aqueous extract and cocoa powder residue; and (h) concentrating the aqueous extract. The cocoa powder starting material is preferably highly deoiled cocoa powder with a fat content of 10 to 12% with a particle size of 15 to 30 micrometer.

Literature regarding extracts from cacao describes processes that start with the cacao bean or cocoa powder, not refined chocolate. For example, U.S. Pat. No. 6,777,005 discloses cocoa extracts such as polyphenols or procyanidins, methods for preparing such extracts, as well as uses for them, especially as antineoplastic agents and antioxidants. Specifically, disclosed therein is a food comprising therapeutically effective amount of a food additive, wherein the food additive comprises a mixture of cocoa polyphenols, which mixture comprises catechin, epicatechin, and cocoa procyanidin oligomers thereof and which mixture is prepared by reducing cocoa beans to a cocoa powder, defatting the cocoa powder, and extracting the cocoa polyphenols from the cocoa powder. The extracts are generally prepared by reducing cocoa beans to a powder, defatting the powder, and extracting the active compound(s) from the defatted powder. The powder can be prepared by freeze-drying the cocoa beans and pulp, depulping the cocoa beans and pulp, dehulling the freeze-dried cocoa beans, and grinding the dehulled beans. The extraction of active compound(s) can be by solvent extraction techniques. The extracts can be purified; for instance, by gel permeation chromatography or by preparative High Performance Liquid Chromatography (HPLC) techniques or by a combination of such techniques.

As another example, U.S. Pat. No. 7,368,144 discloses a process for obtaining a cocoa extract comprising a polyphenol compound and a lipid compound contained in cocoa, said process consisting essentially of: obtaining kernels from fresh untreated beans, or dried beans which have not been defatted, said kernels having been obtained from said beans by removing the pulp and shell from said beans, crushing said kernels, in the presence of at least one solvent to produce crushed kernels, macerating the crushed kernels under conditions to extract said compounds in a maceration mixture, filtering said maceration mixture to obtain a filtrate, and recovering said extract from said filtrate.

In view of the high caloric content and marginal measurable physiological effects of existing cocoa-based and chocolate products, there is a need in the art to provide cacao-based products that separate the purported health benefits of the same from the adverse attributes while providing significant physiological benefits. Such an approach would provide the ability to consume more of the beneficial components to increase purported healthful effects while avoiding the adverse attributes. There is also a need in the art to provide cacao-based products providing significant physiological benefits thereof, regardless of the caloric content. The disclosure herein addresses these problems and needs in the art by disclosing and describing extracts of chocolate, a process of making the same, and uses of said products. The products have a significantly reduced fat content, or virtually no fat, can contain sugar or a minimal amount of sugar, while providing physiological benefits in a much more bio-available form. Importantly, the products disclosed herein are pleasant tasting in contrast to the very bitter and astringent tasting (unpalatable) cacao-derived products disclosed by others.

### SUMMARY

In an embodiment, a process of making a chocolate extract is disclosed, comprising: (a) combining a chocolate source with a water miscible solution to form a mixture; (b) heating the mixture to melt the chocolate source to form a melted chocolate mixture; (c) mixing the melted chocolate mixture to form a slurry comprising a water miscible phase, an oil phase, and a solid particle phase; (d) separating the water miscible phase from the oil phase and the solid particle phase; and (e) recovering the water miscible phase, whereby the water miscible phase is the chocolate extract.

In an embodiment, a process of making a chocolate extract is disclosed, comprising: (a) mixing a chocolate source with a water miscible solution, wherein the water miscible solution melts the chocolate source, wherein the water miscible solution and the chocolate source form a mixture comprising a water miscible phase, an oil phase, and a solid particle phase; (b) separating the water miscible phase from the oil phase and the solid particle phase; and (c) recovering the water miscible phase, whereby the water miscible phase is the extract of chocolate.

In an embodiment, a process of making a chocolate extract is disclosed, comprising: (a) mixing a chocolate source with a water miscible solution, wherein the chocolate source is in a liquid state and the water miscible solution is at a temperature that does not solidify the chocolate source, wherein the water miscible solution and the chocolate source form a mixture comprising a water miscible phase, an oil phase, and a solid particle phase; (b) separating the water miscible phase from the oil phase and the solid particle phase; and (c) recovering the water miscible phase, whereby the water miscible phase is the extract of chocolate.

In an embodiment, chocolate extract is disclosed, where the extract has less than 1% residual cocoa solids, less than 1% residual cocoa fat, and one or more bioactive chemical species capable of lowering blood pressure after consumption of the chocolate extract. The bioactive chemical species are from an extraction process. The extraction process comprises: (a) mixing a chocolate source with a water miscible solution, wherein the water miscible solution and the chocolate source form a mixture comprising a water miscible phase, an oil phase, and a solid particle phase; (b) separating the water miscible phase from the oil phase and the solid particle phase; and (c) recovering the water miscible phase, whereby the water miscible phase is the extract of chocolate.

In an embodiment, a process of making a chocolate extract is disclosed, comprising: (a) means for mixing a chocolate source with a water miscible solution to form a mixture comprising a water miscible phase, an oil phase, and a solid particle phase; (b) means for separating the water miscible phase from the oil phase and the solid particle phase; and (c) means for recovering the water miscible phase, whereby the water miscible phase is the extract of chocolate.

### BRIEF DESCRIPTION OF THE DRAWINGS

FIG. 1 provides a flow diagram of an embodiment disclosed herein for the process of making a chocolate extract. The process as shown includes steps associated with the chocolate-making process itself starting with the raw cocoa bean.

FIG. 2a provides a liquid chromatogram (HPLC) of an astringent tasting 23% ethanol extract with an unpleasant odor derived from Ghirardelli brand cocoa powder produced by a hydraulic pressing (expeller pressing) cocoa powder manufacturing process. Abscissa indicates retention time, ordinate axis indicates total ion count (positive ion mode). Peak labeled 202 is theobromine, peak labeled 204 is epicatechin or catechin (with short retention time), peak labeled 206 is caffeine, peak labeled 208 is procyanidin B2, peak labeled 210 is a polyphenol, peak labeled 212 is a polyphenol, peak labeled 214 is epicatechin or catechin (with longer retention time), peaks labeled 216 are a mixture of procyanidin derivatives and procyanidin glycosides.

FIG. 2b provides a liquid chromatogram (HPLC) of 23% ethanol extract derived from cocoa powder. Abscissa indicates retention time, ordinate axis indicates ion count (positive ion mode) for theobromine, epicatechin/catechin, procyanidin and caffeine shown on four separate chomatograms where the signature ions were present as determined by the mass spectrometry analysis.

FIG. 3a provides a liquid chromatogram (HPLC) of 23% ethanol extract derived from 70% dark chocolate made without hydraulic pressing (expeller pressing) process with a mild, sweet flavor and a pleasant odor. The theobromine signal is of equal magnitude comparing between chocolate and cocoa powder (FIG. 3 vs FIG. 2) but all other major constituents are distinct between cocoa powder and chocolate. Abscissa indicates retention time, ordinate axis indicates total ion count (positive ion mode). Peak labeled 302 is theobromine, peak labeled 304 is epicatechin or catechin (with short retention time), peak labeled 306 is caffeine, peak labeled 308 is procyanidin B2, peak labeled 310 is a polyphenol, peak labeled 312 is a polyphenol, peak labeled 314 is epicatechin or catechin (with longer retention time), peaks labeled 316 are a mixture of procyanidin derivatives and procyanidin glycosides.

FIG. 3b provides a liquid chromatogram (HPLC) of 23% ethanol extract derived from 70% dark chocolate (solid thin line) versus cocoa powder (dotted line). Abscissa indicates retention time, ordinate axis indicates total ion count (positive ion mode). Peak labeled 302 is theobromine, peak labeled 304 is epicatechin or catechin (with short retention time), peak labeled 306 is caffeine, peak labeled 308 is procyanidin B2, peak labeled 310 is a polyphenol, peak labeled 312 is a polyphenol, peak labeled 314 is epicatechin or catechin (with longer retention time), peaks labeled 316 are a mixture of procyanidin derivatives and procyanidin glycosides.

FIG. 3c provides a liquid chromatogram (HPLC) of 23% ethanol extract derived from 70% dark chocolate. Abscissa indicates retention time, ordinate axis indicates ion count (positive ion mode) for theobromine, epicatechin/catechin, procyanidin and caffeine shown on four separate chomatograms where the signature ions were present as determined by the mass spectrometry analysis.

FIG. 4 provides the liquid chromatography (HPLC), mass spectroscopy (MS) conditions used in FIG. 2A, FIG. 2B, FIG. 3A, FIG. 3B, FIG. 3C, FIG. 5, FIG. 6, FIG. 7, FIG. 8, FIG. 9, FIG. 10a-10k, FIG. 11a-11h.

FIG. 5 provides a liquid chromatogram (HPLC analysis) of 96% ethanol (solvent) used for extraction of chocolate. Abscissa indicates retention time, ordinate axis indicates total ion count (positive ion mode).

FIG. 6 provides a liquid chromatogram (HPLC analysis) of 25% ethanol, 75% water solvent after extraction of chocolate. Abscissa indicates retention time, ordinate axis indicates total ion count (positive ion mode).

FIG. 7 provides a liquid chromatogram (HPLC analysis) of 50% ethanol, 50% water solvent after extraction of chocolate. Abscissa indicates retention time; ordinate axis indicates total ion count (positive ion mode).

FIG. 8 provides a liquid chromatogram (HPLC analysis) of 75% ethanol, 25% water solvent after extraction of chocolate. Abscissa indicates retention time; ordinate axis indicates total ion count (positive ion mode).

FIG. 9 provides a liquid chromatogram (HPLC analysis) of 96% ethanol, 4% water solvent after extraction of chocolate. Abscissa indicates retention time; ordinate axis indicates total ion count (positive ion mode).

FIG. 10a provides a liquid chromatogram (HPLC analysis) of 25% ethanol, 75% water solvent after extraction of chocolate. Abscissa indicates retention time; ordinate axis indicates total ion count (positive ion mode). Numbers indicate peaks integrated for mass spectrometry analysis. Peak numbers correspond to numbers in the top right of the mass spectrometry analysis in FIG. 10b through FIG. 10k.

FIG. 10b to FIG. 10k provide the mass spectrometry analysis of liquid chromatogram peaks from FIG. 10a (HPLC analysis of 25% ethanol, 75% water solvent after extraction of chocolate. Abscissa indicates mass-to-charge ratios in m/z, ordinate axis indicates signal intensity corresponding to ion count (positive ion mode). The mass spectra corresponding to four peaks on the liquid chromatogram in are shown per figure.

FIG. 11a provides a liquid chromatogram (HPLC analysis) of 96% ethanol, 4% water solvent after extraction of chocolate. Abscissa indicates retention time; ordinate axis indicates total ion count (positive ion mode). Numbers indicate peaks integrated for mass spectrometry analysis. Peak numbers correspond to numbers in the top right of the mass spectrometry analysis in FIG. 11b through FIG. 11h.

FIG. 11b to FIG. 11h provide the mass spectrometry analysis of liquid chromatogram peaks from FIG. 11a (HPLC analysis of 96% ethanol, 4% water solvent after extraction of chocolate. Abscissa indicates mass-to-charge ratios in m/z, ordinate axis indicates signal intensity corresponding to ion count (positive ion mode). The mass spectra corresponding to four peaks on the liquid chromatogram in FIG. 11a are shown per figure (FIG. 11c-FIG. 11h) and the mass spectra corresponding to two peaks on the chromatogram in FIG. 11a are shown in FIG. 11b.

FIG. 12a provides a gas chromatograph (GC) analysis of 25% ethanol, 75% water extraction of chocolate (solid line). Dotted line indicates the profile of solvent only. Abscissa indicates retention time; ordinate axis indicates total ion count (positive ion mode).

FIG. 12b to FIG. 12l provide the mass spectrometry profile of major peaks in the gas chromatogram shown in FIG. 12a. Abscissa indicates mass-to-charge ratios in m/z, ordinate axis indicates signal intensity corresponding to ion count (positive ion mode). The retention time for each mass spectra is indicated above the mass spectrograph and database-based identification and structure is indicated at the top of each figure

FIG. 13 provides the gas chromatography mass spectrometry conditions used in FIG. 12a (gas chromatogram) and FIG. 12b through FIG. 12l (mass spectra of gas chromatogram peaks)

### DETAILED DESCRIPTION

Disclosed herein is an extract of refined chocolate, a process of making the extract, and uses of the extract. In an embodiment, the extract disclosed herein addresses the problems of high caloric content and marginal measurable physiological effects of existing cocoa-based and chocolate products. This extract provides the ability to consume more of the beneficial components to increase purported healthful effects while avoiding adverse attributes. In another embodiment, the extract provides significant physiological benefits without consideration of the caloric content. Preferably, the extracts have only trace amounts of residual cocoa fat. In an embodiment, the extract may have sugar from the chocolate used in the process of making the extract. In another embodiment, the extract may have only a trace amount of sugar or no significant amount of sugar. In another embodiment, an artificial sweetener is added to the extract. In all embodiments, physiological benefits of chocolate are provided in a much more bio-available form. In an embodiment, the chocolate extract has ethyl alcohol.

Without being bound by theory, the lack of significant physiological effects of currently available cacao-based products could be for any of the following possibilities: (i) the biologically active component/components has/have been missed; (ii) the bioactivity lies in a combination of chemical entities or metabolites that produce synergistic drug interactions; (iii) the bioactivity lies in a combination of chemical entities or metabolites that act synergistically to aid adsorption in the intestinal tract, i.e. one molecule acts as a transporter and another molecule is an active species that cannot be adsorbed without the presence of the carrier molecule; (iv) certain moieties tend to bind strongly to the cocoa lipids and/or cocoa solids, minimizing adsorption from bulk material in the intestinal tract (also tending to confound purification, i.e. many have described purifying material from cocoa powders but very little with a significant effect); (v) chemical activity may be higher in chocolate than in cocoa powder or chocolate liquor since the manufacturing process, especially conching, chemically alters chocolate, where new compounds are formed as well as other compounds disappearing; (vi) the extraction process itself, possibly in combination with the chocolate manufacturing process, especially conching, may change the chemical species present in chocolate; or (vii) some combination of the above.

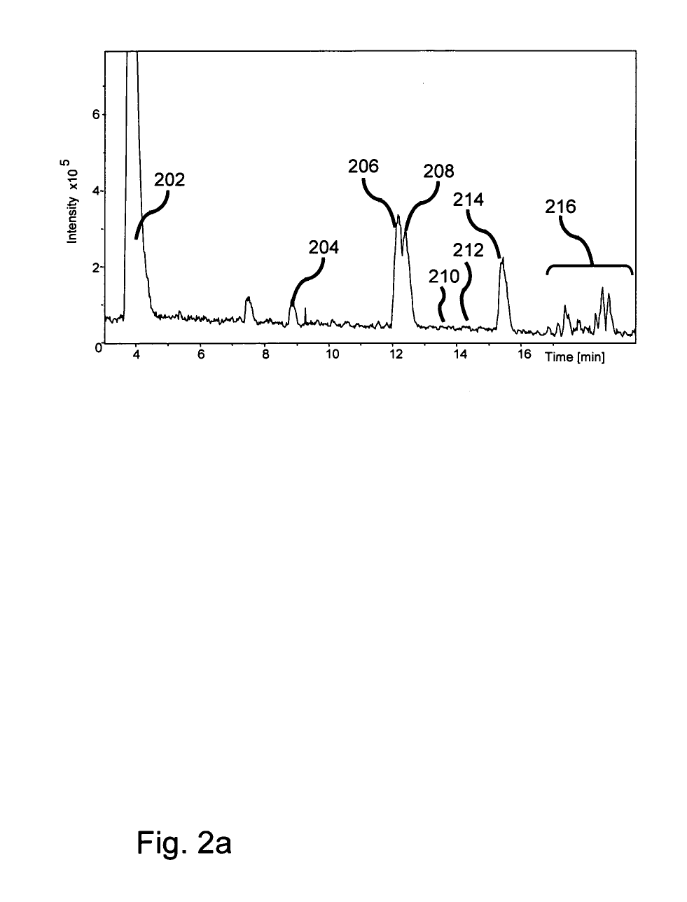

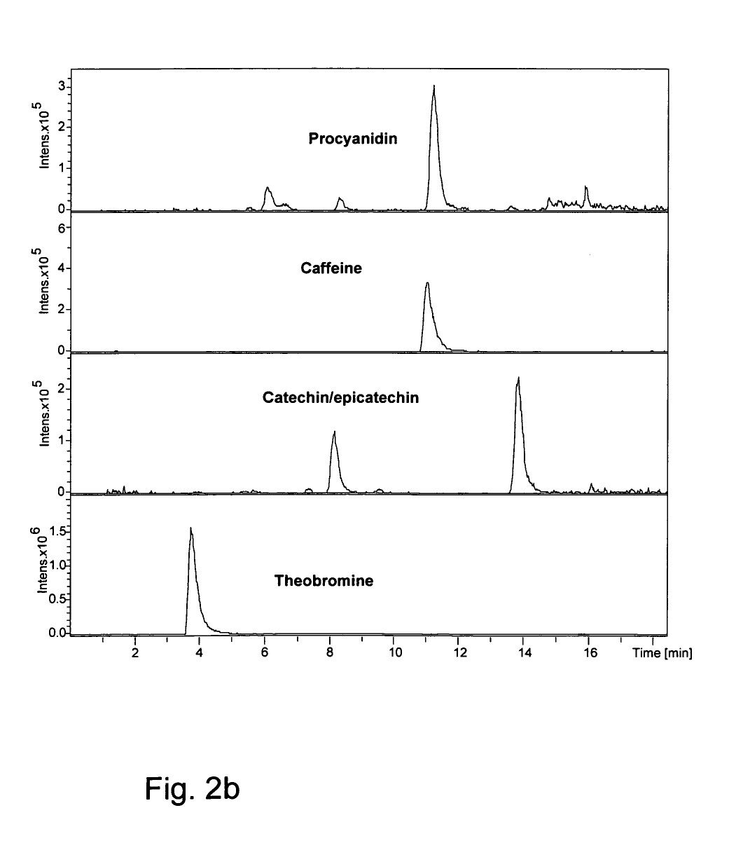

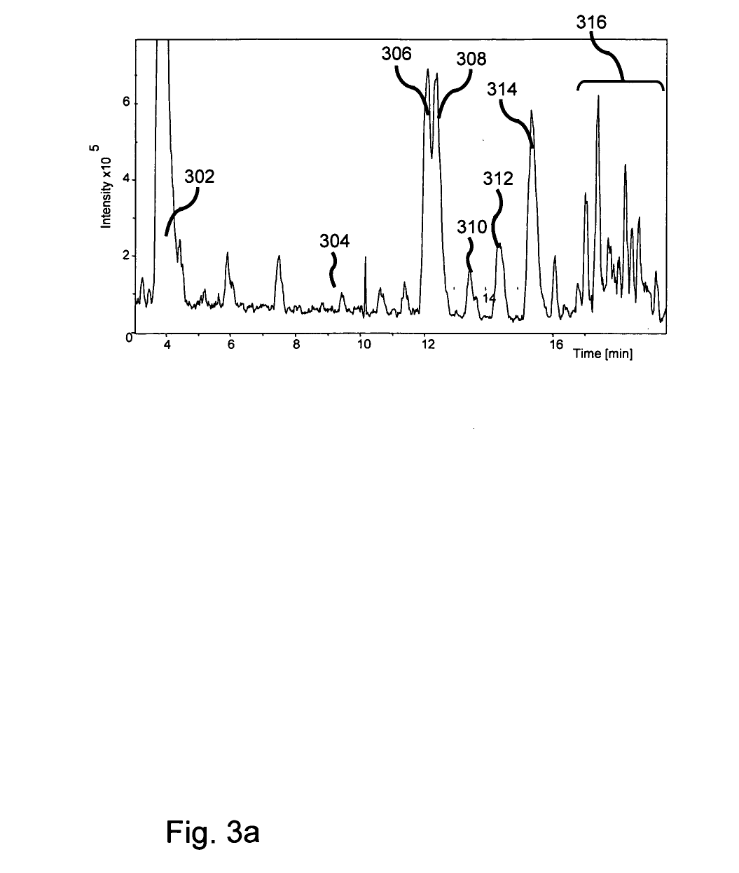

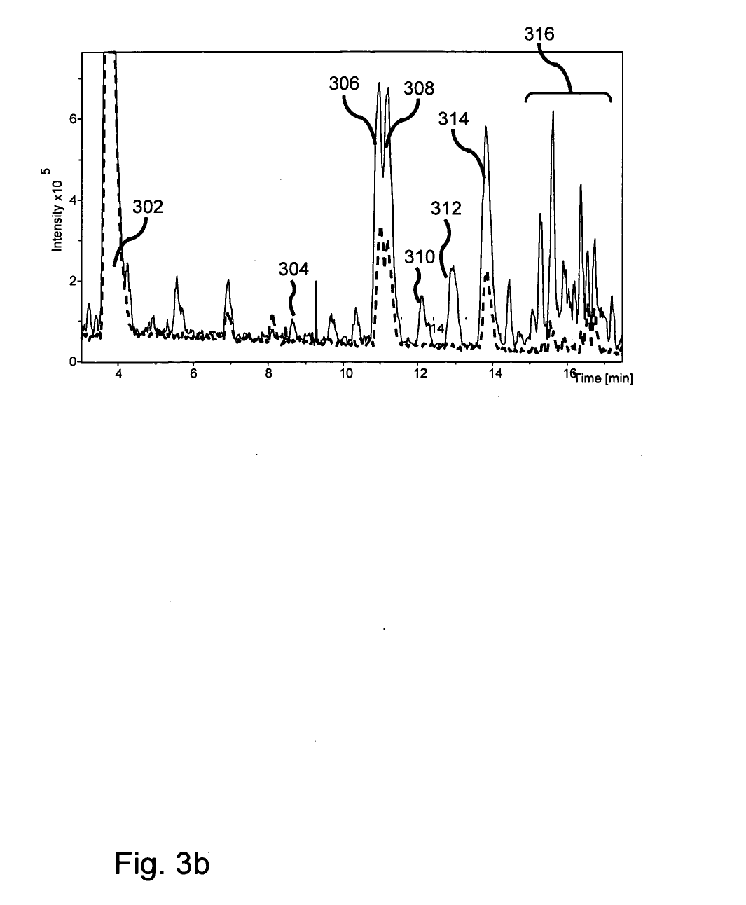

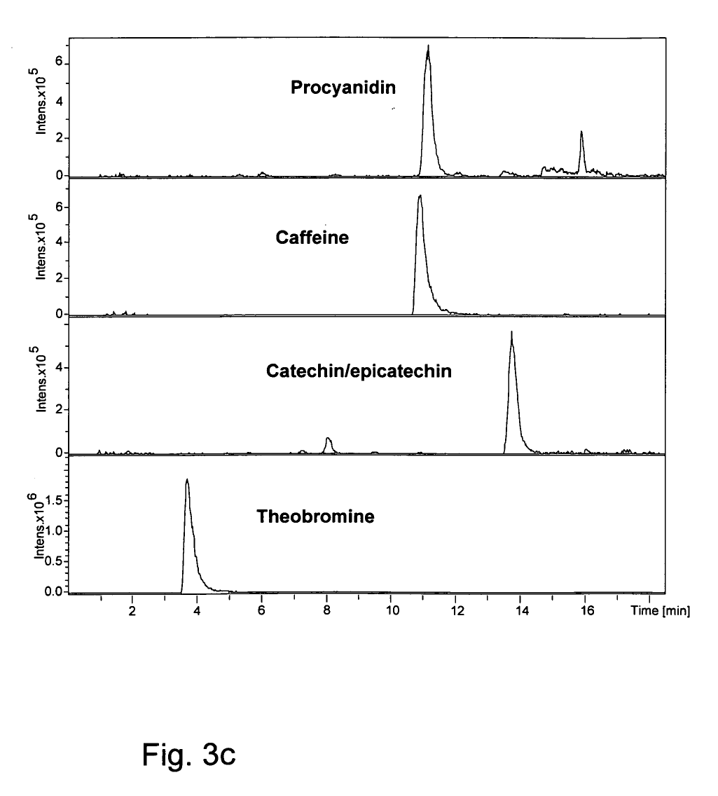

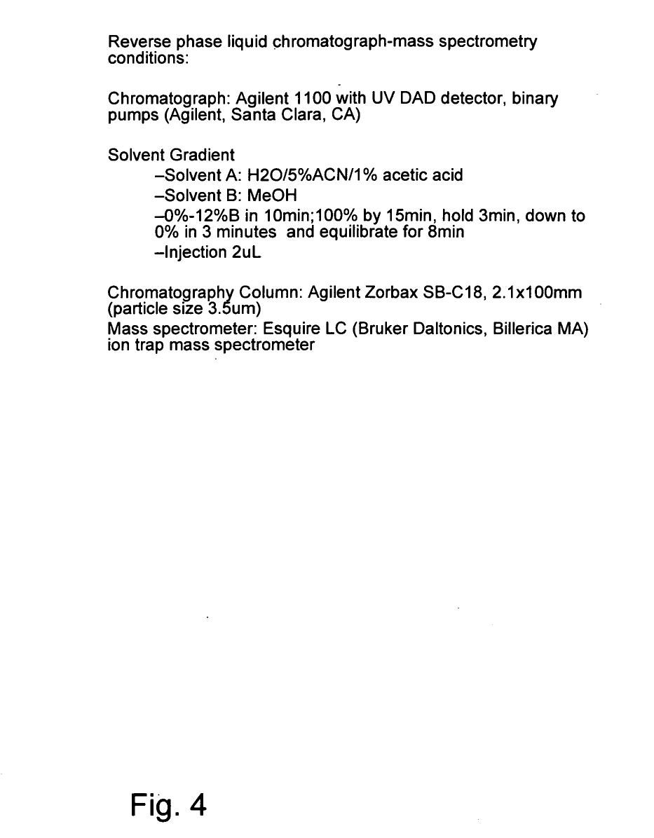

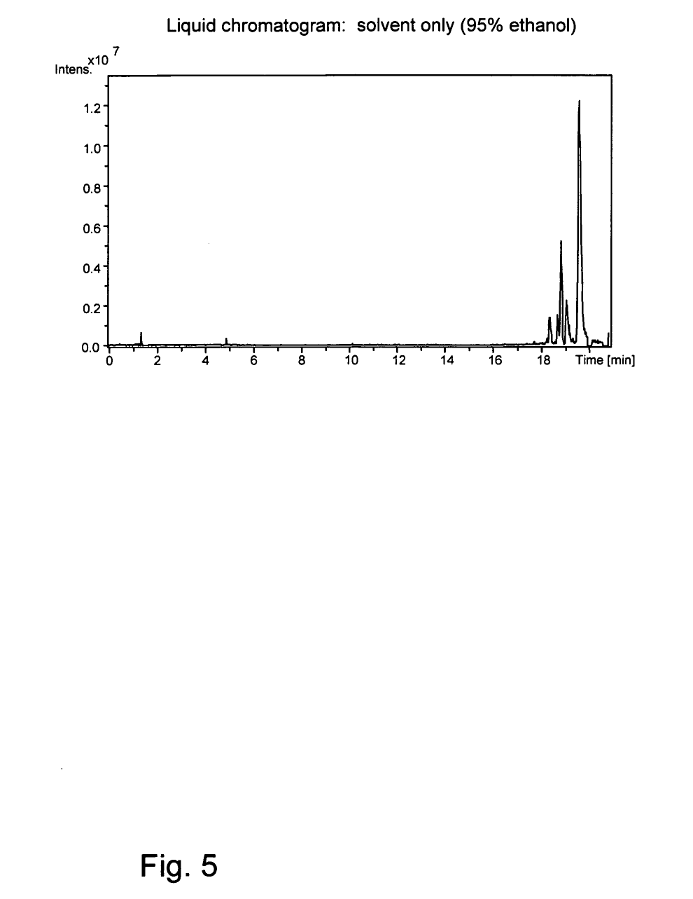

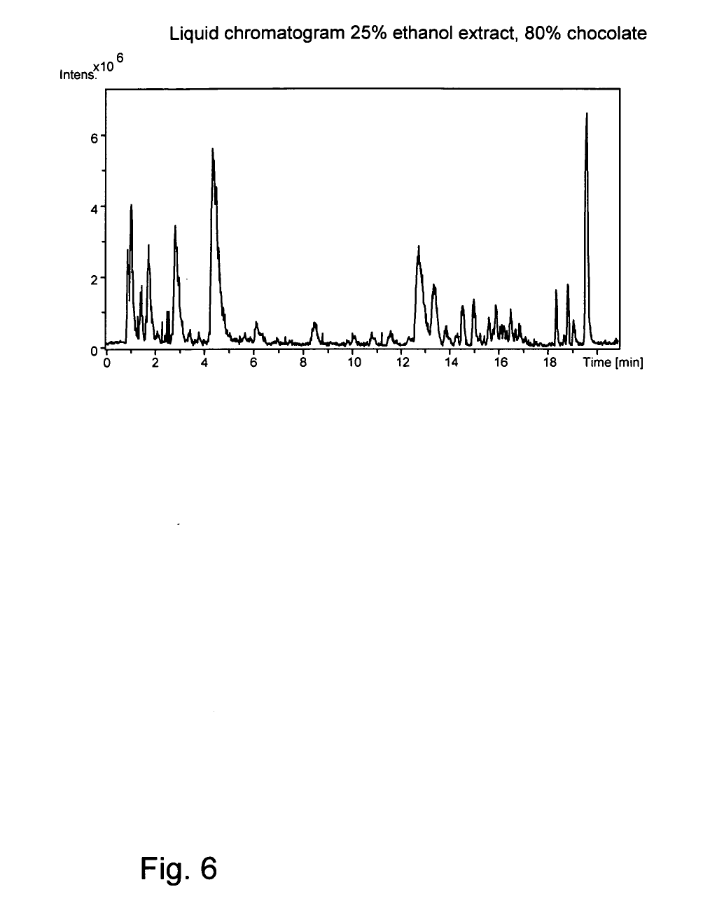

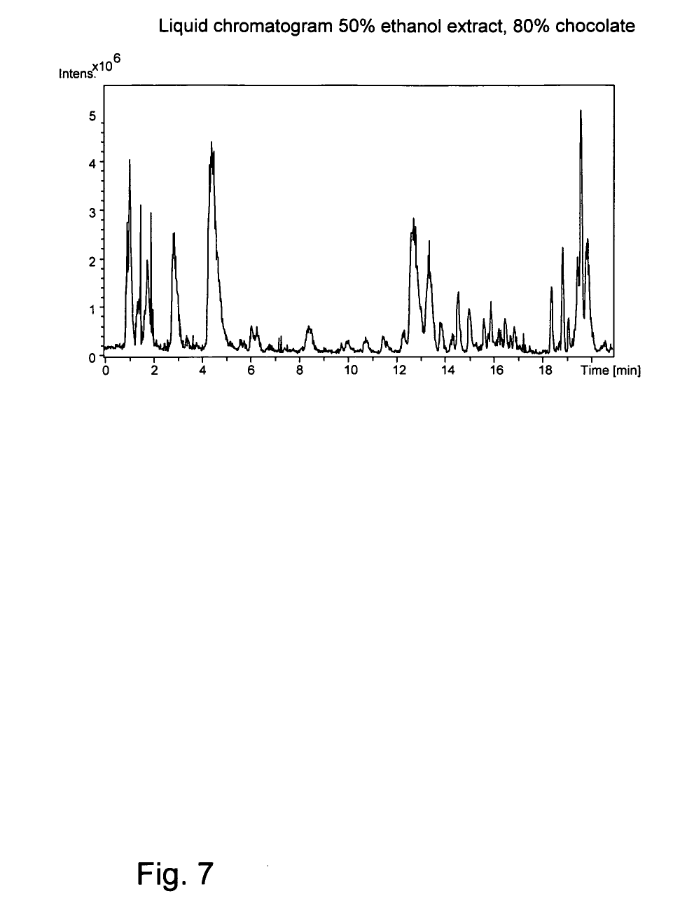

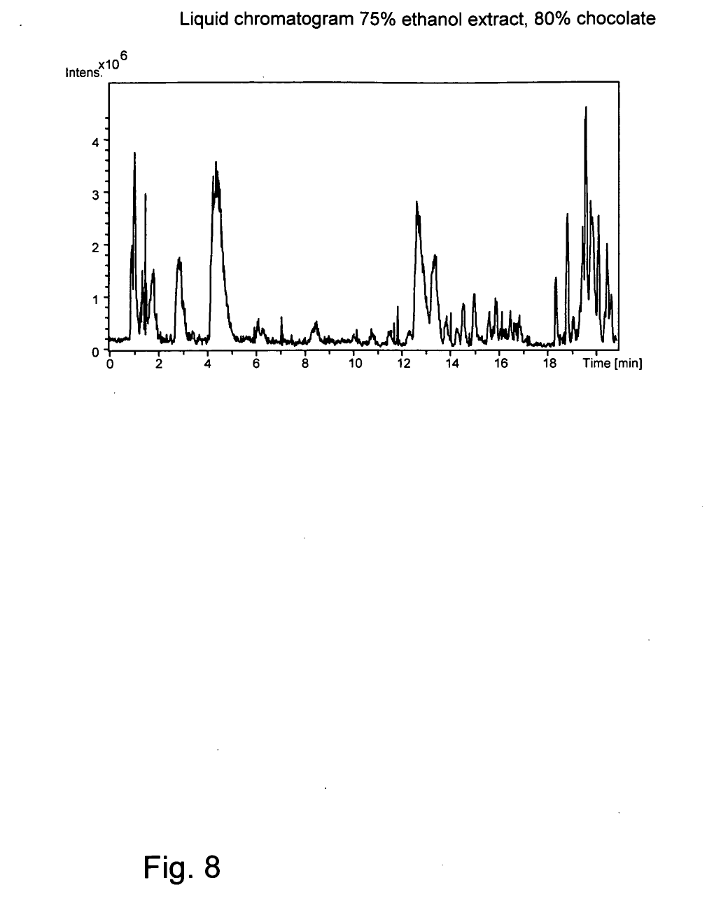

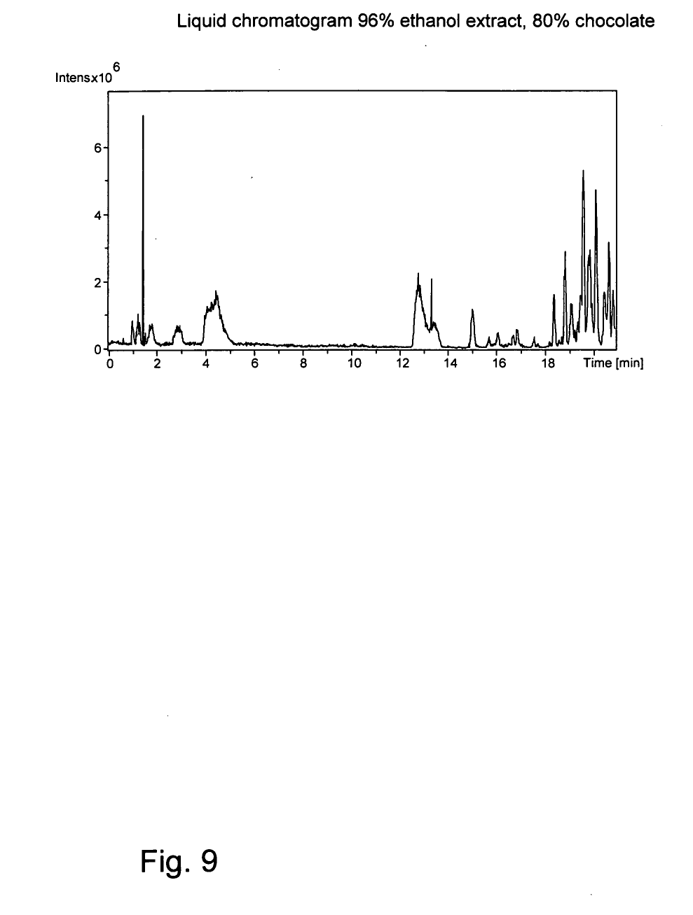

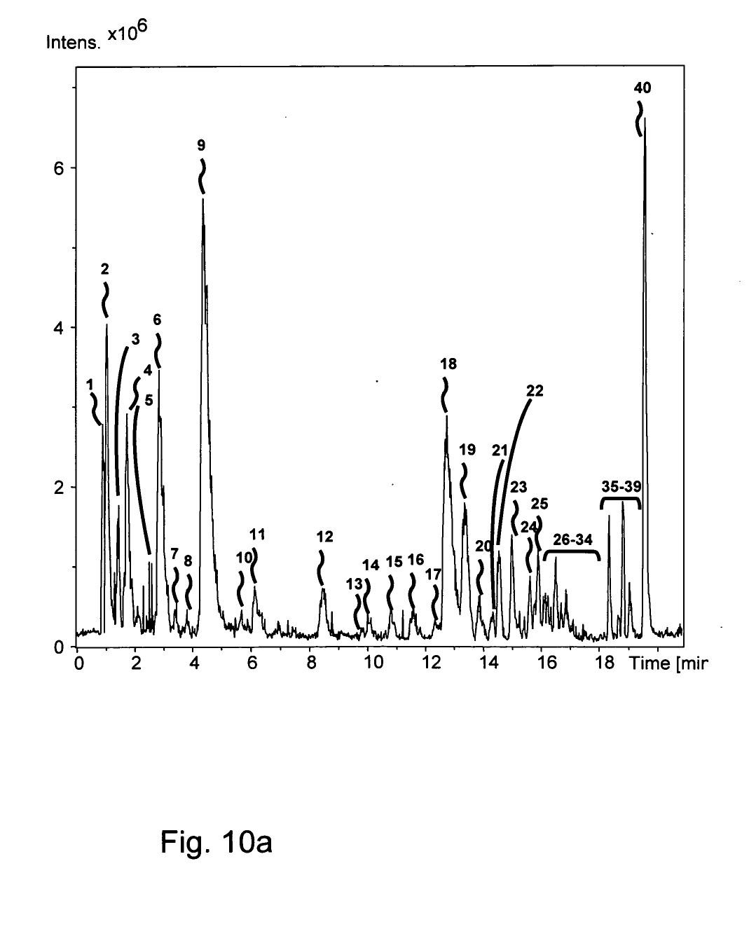

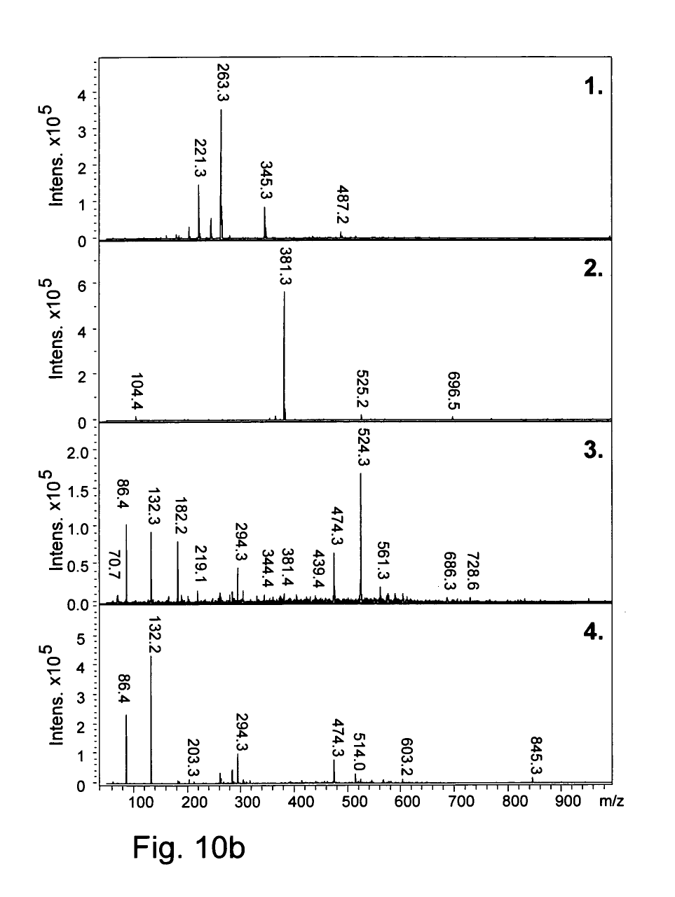

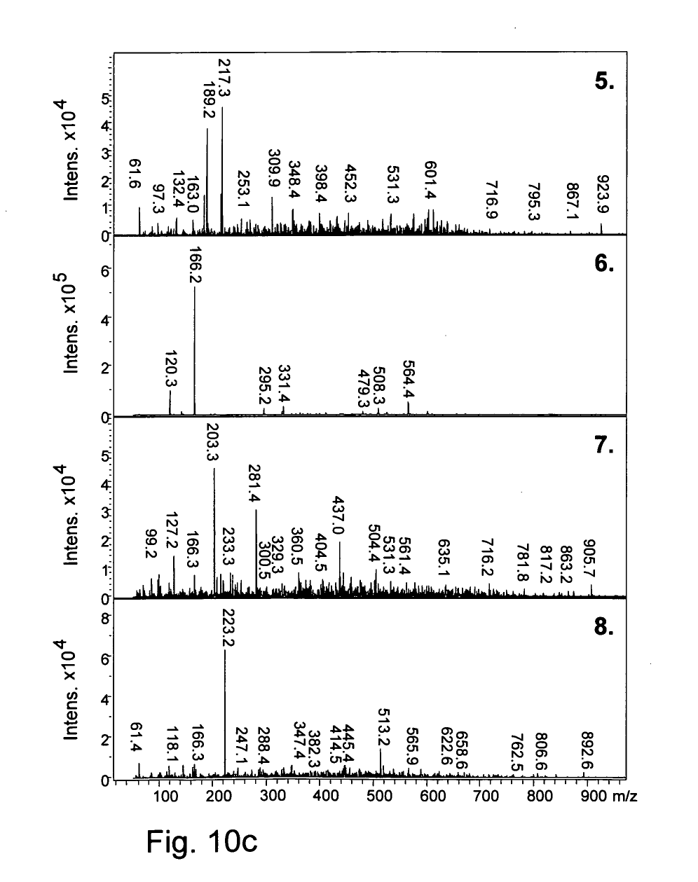

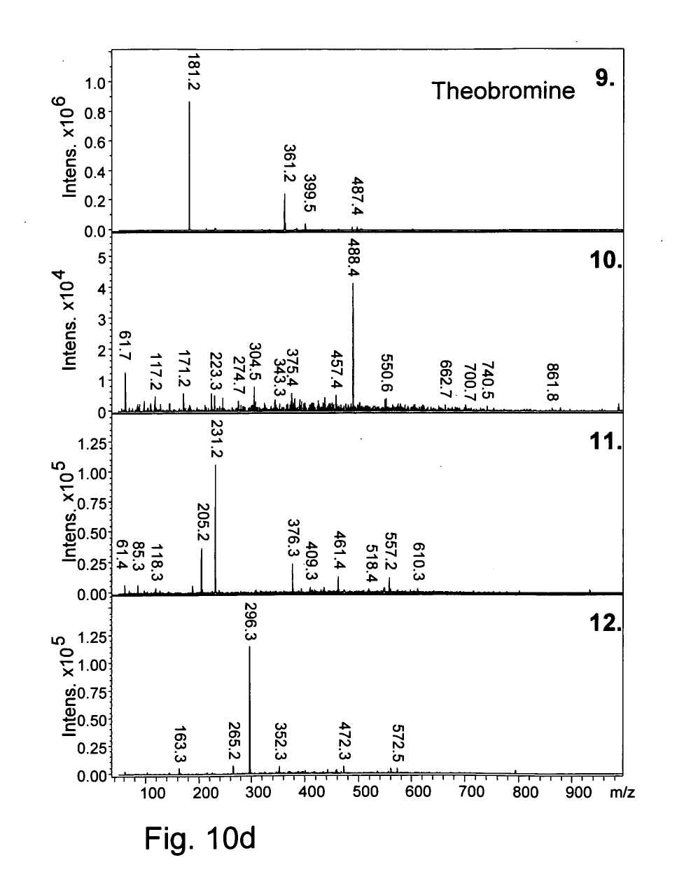

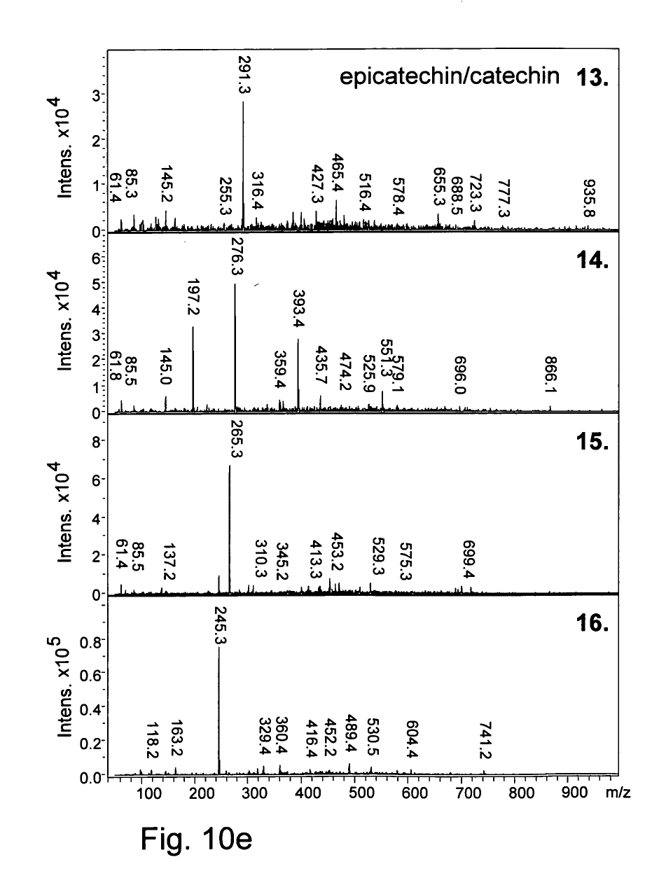

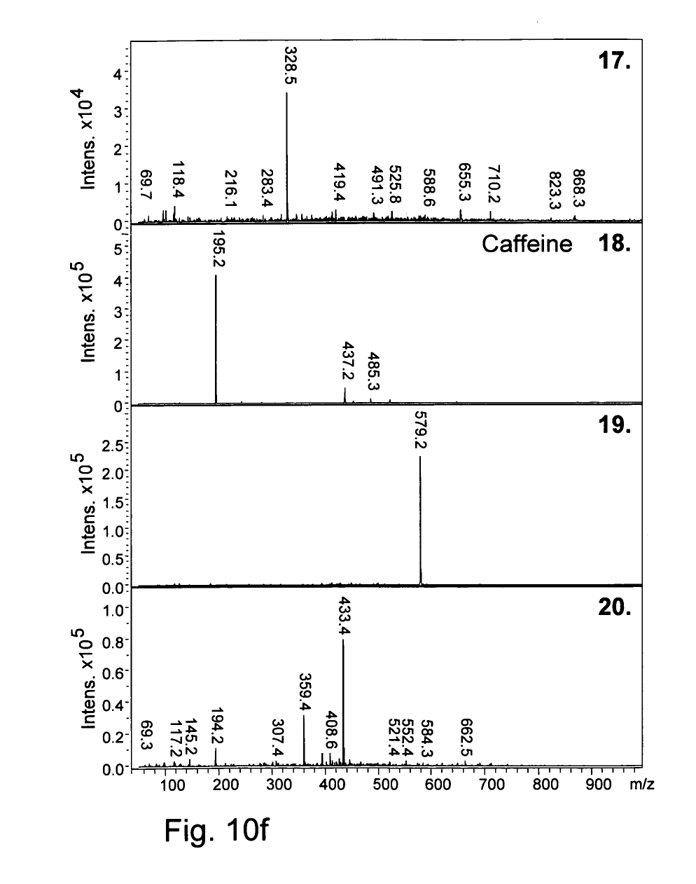

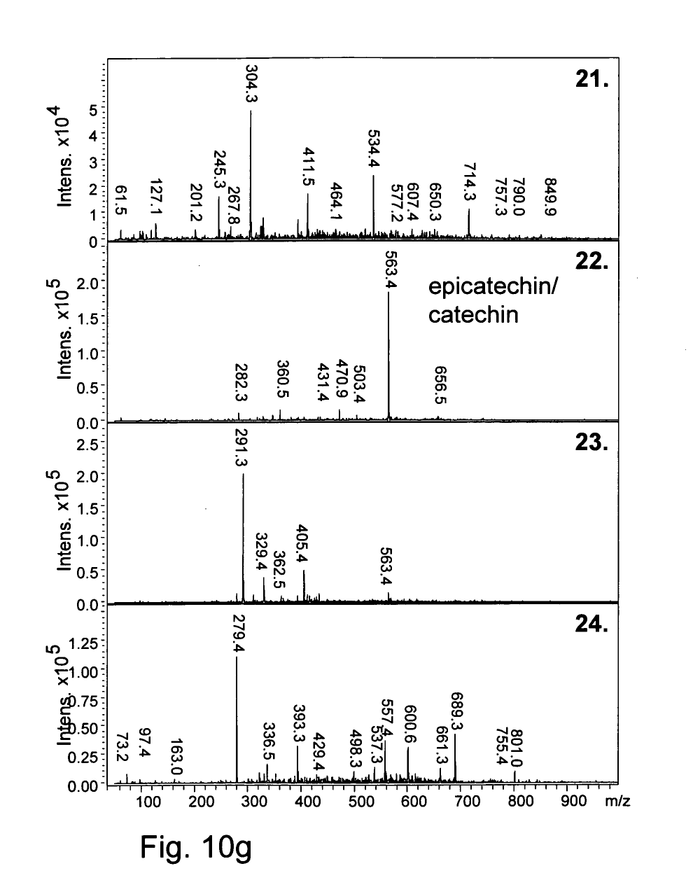

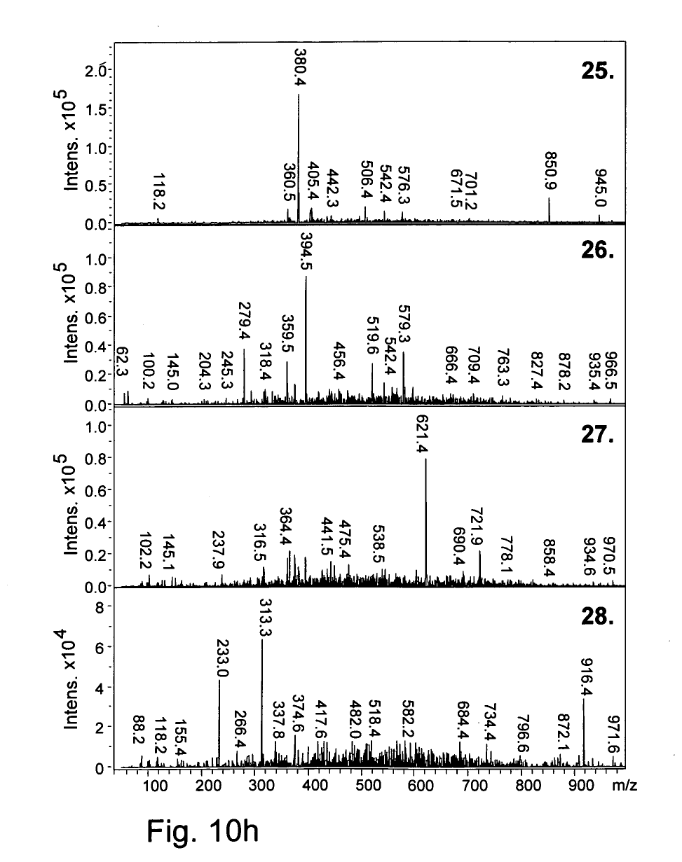

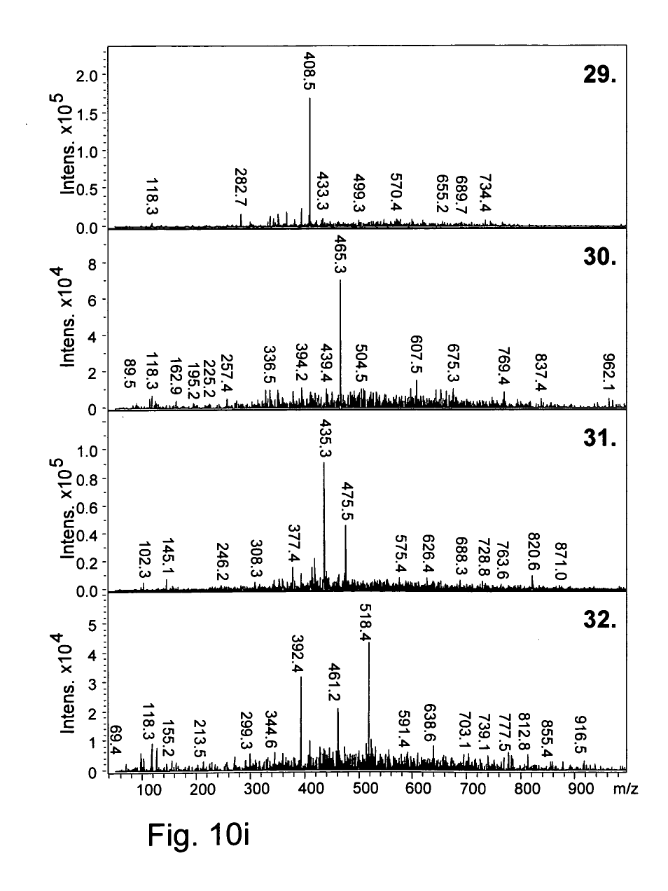

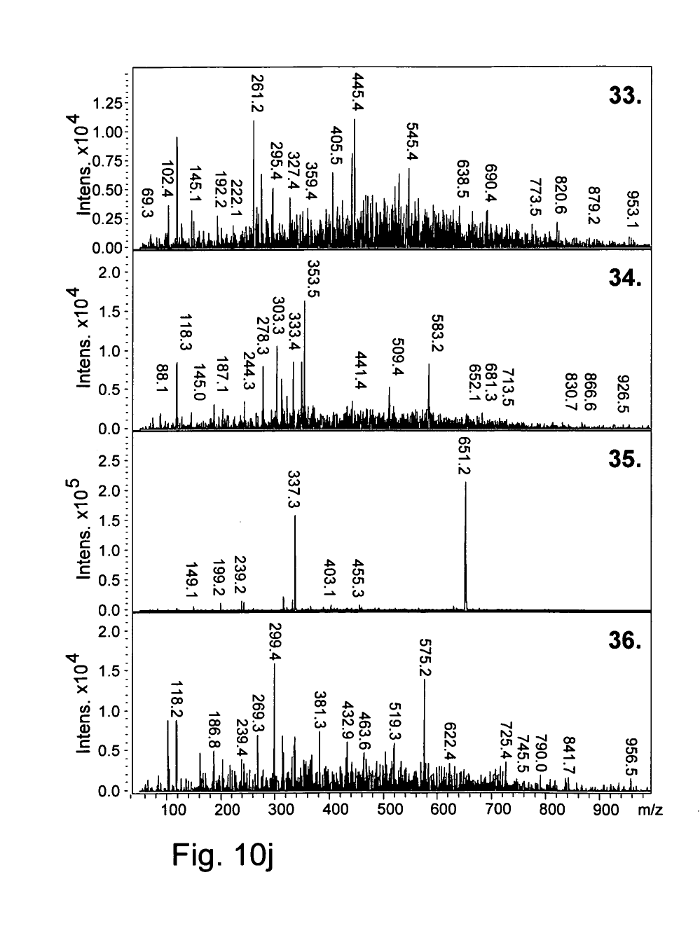

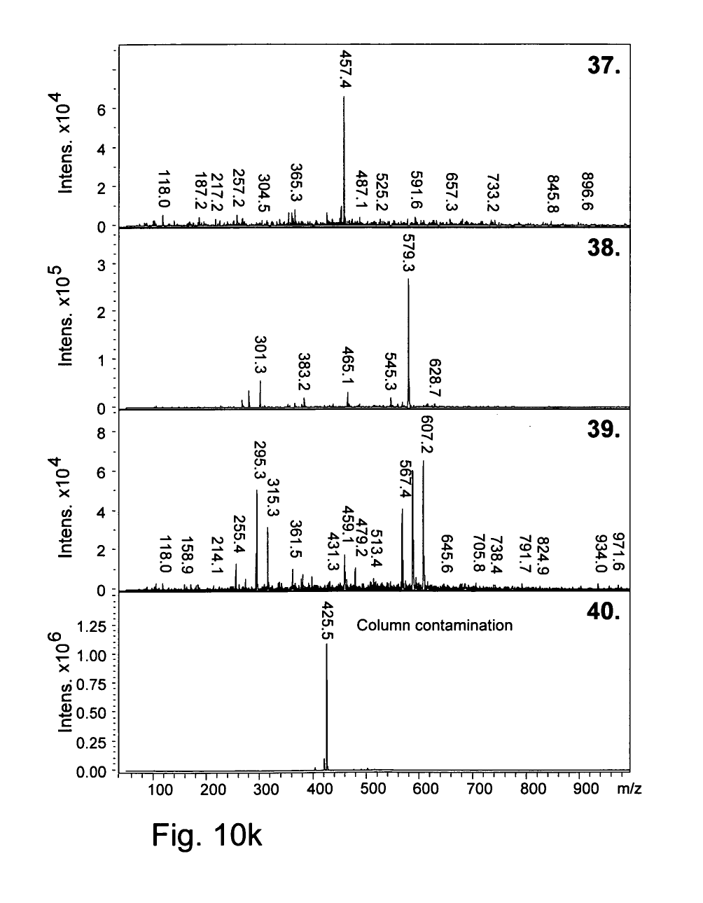

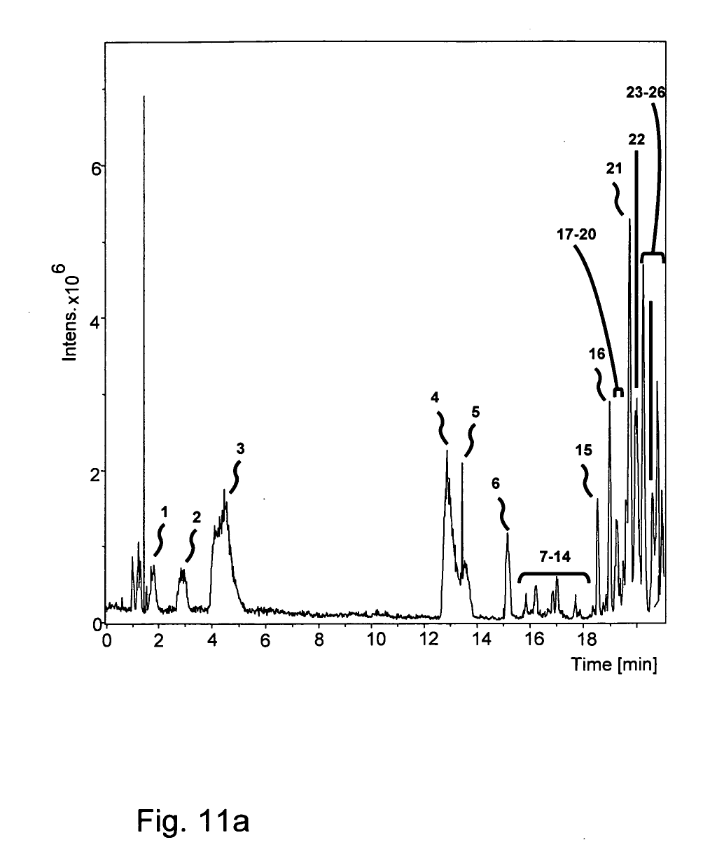

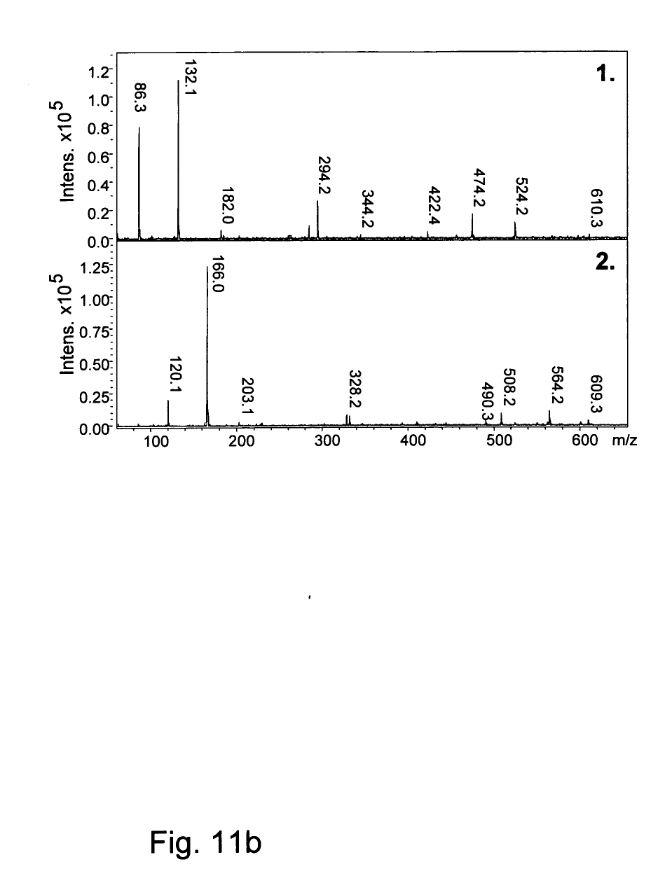

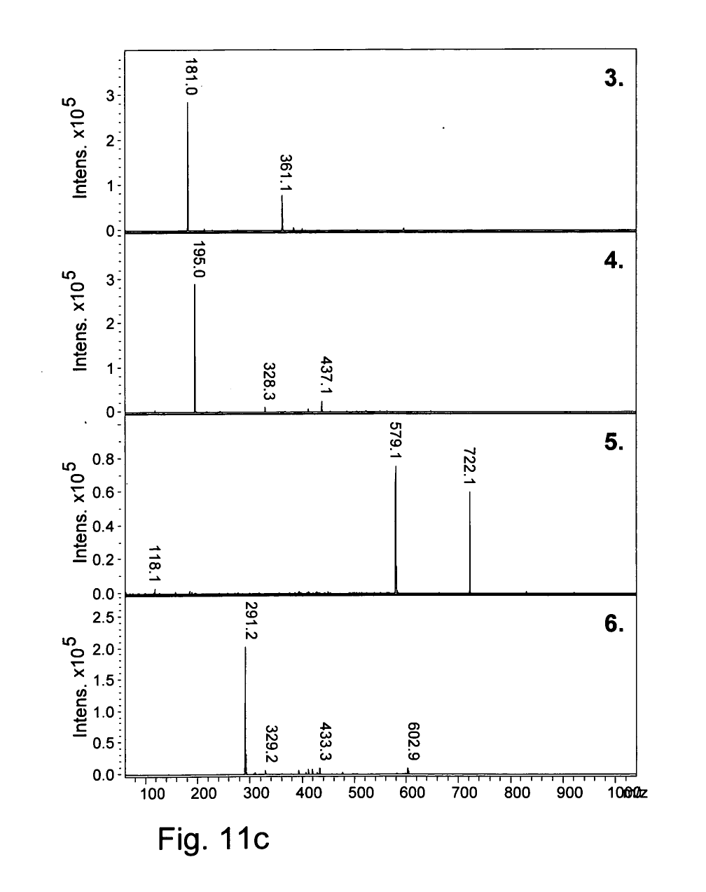

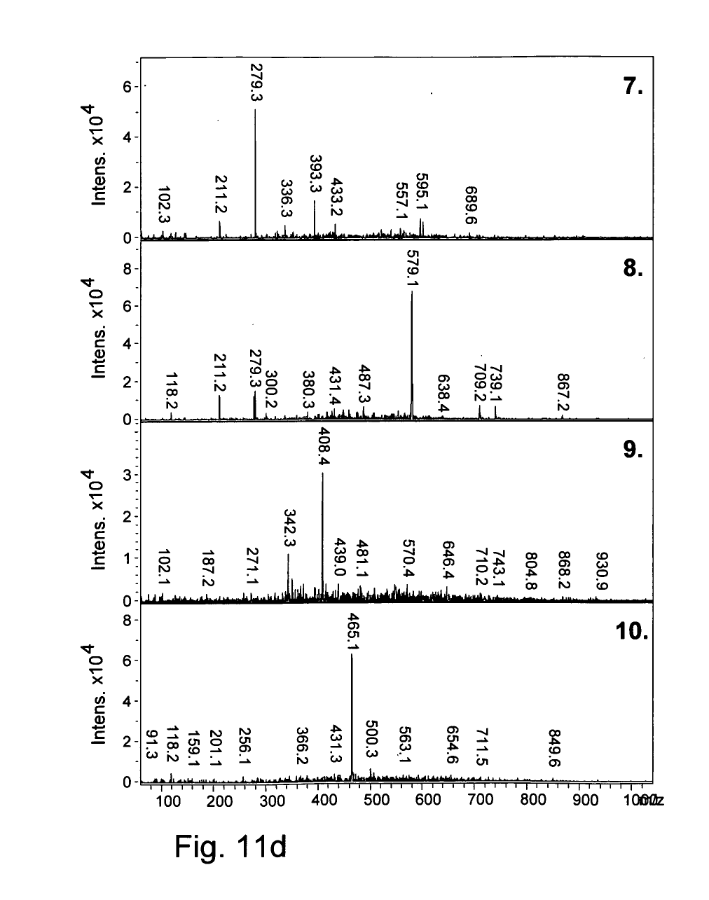

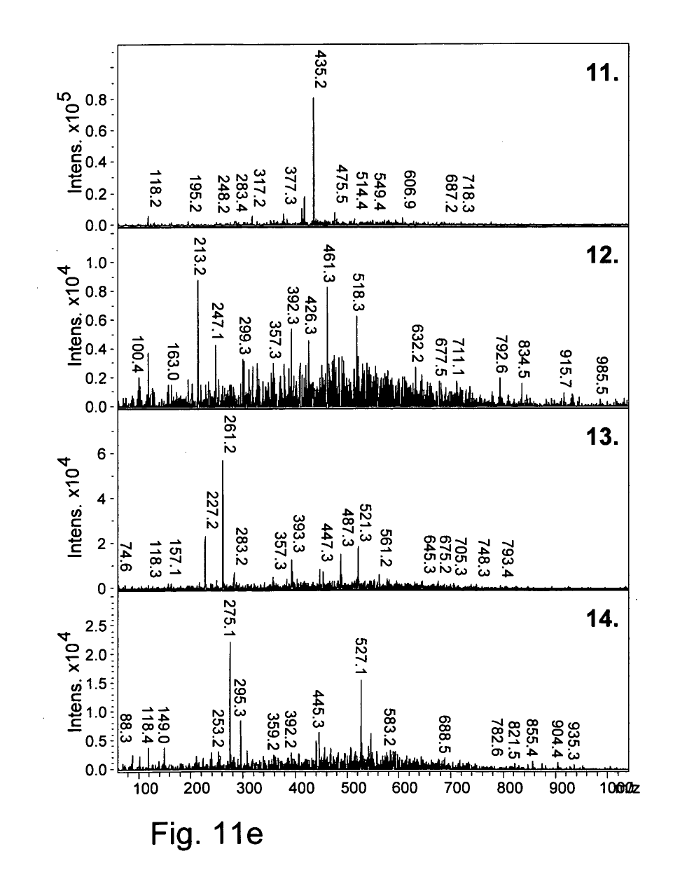

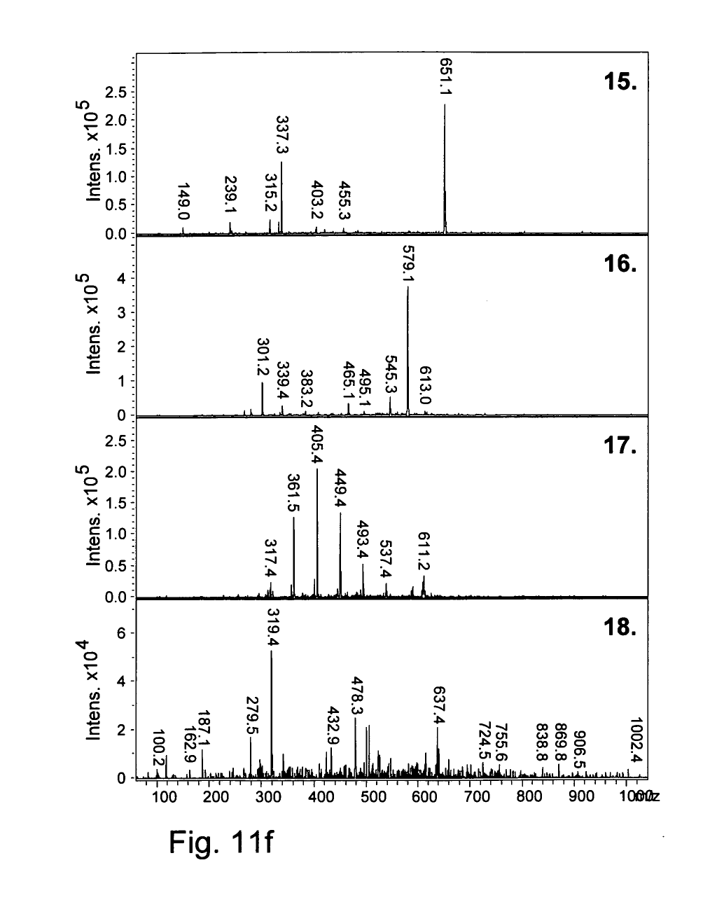

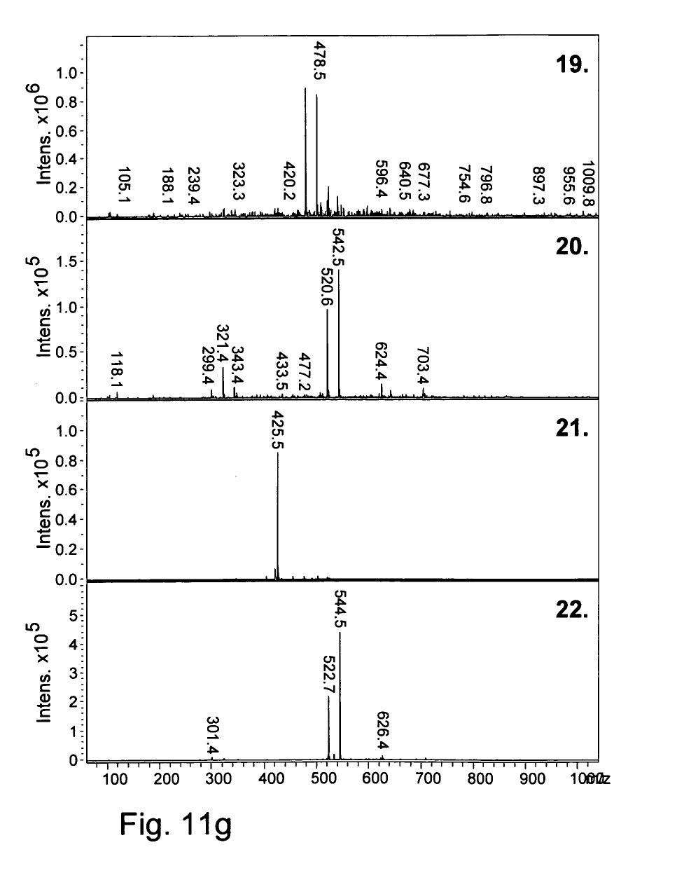

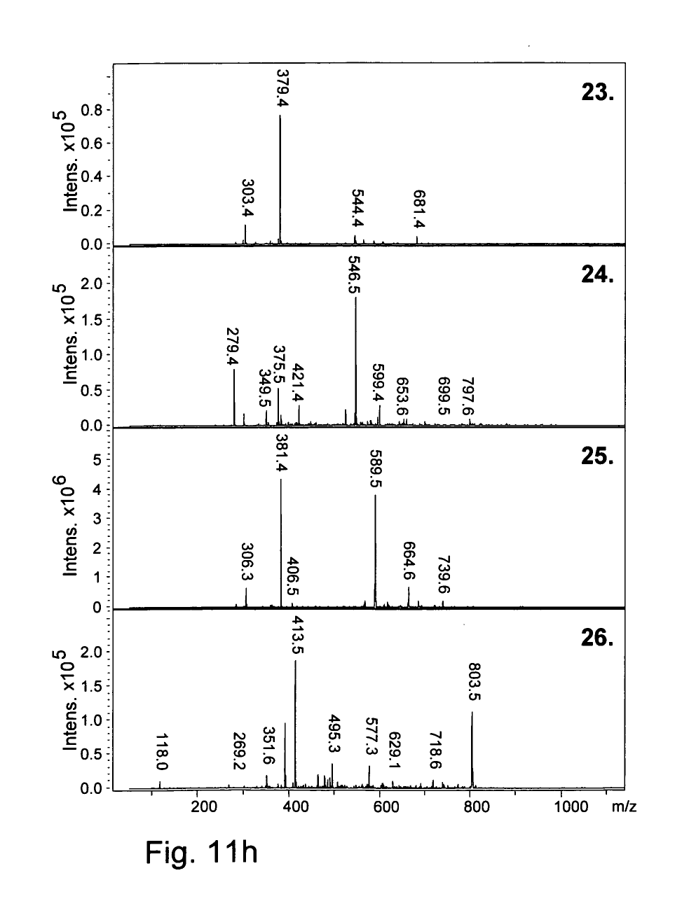

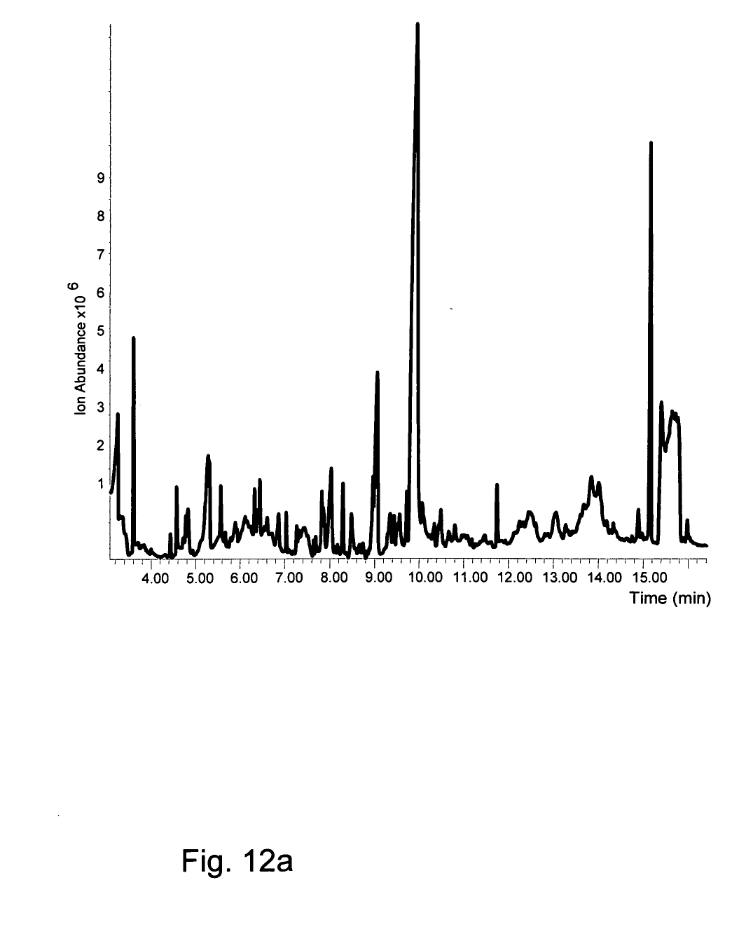

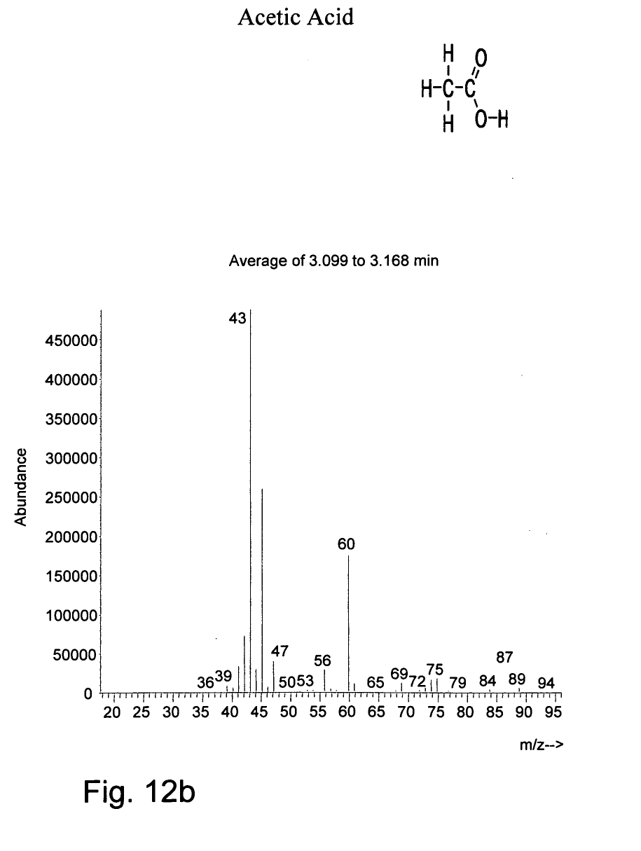

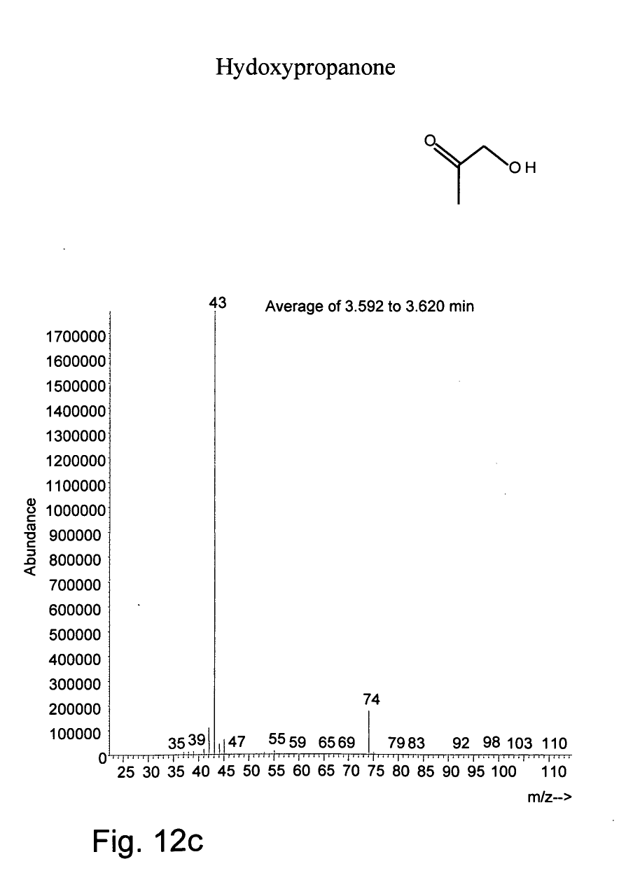

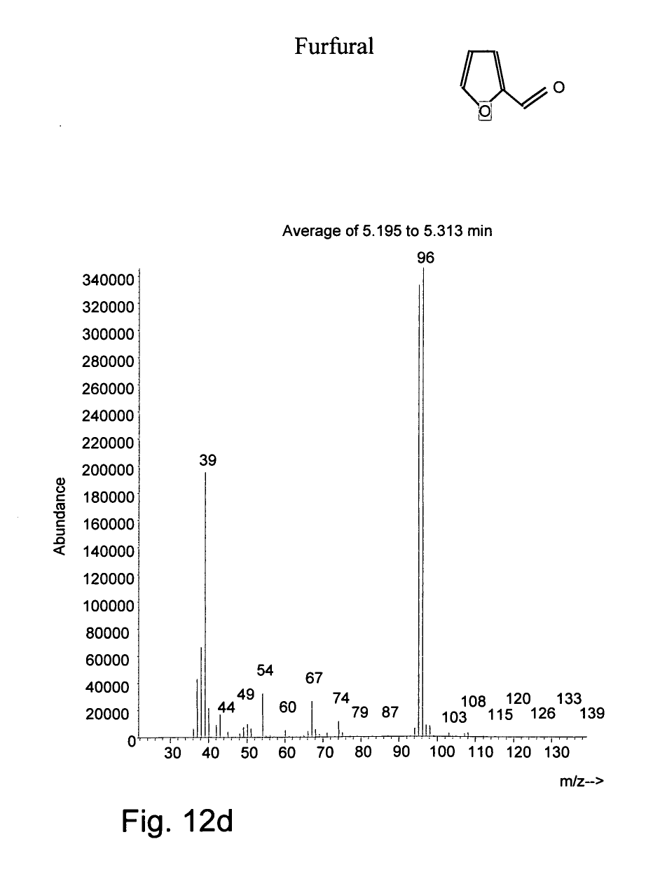

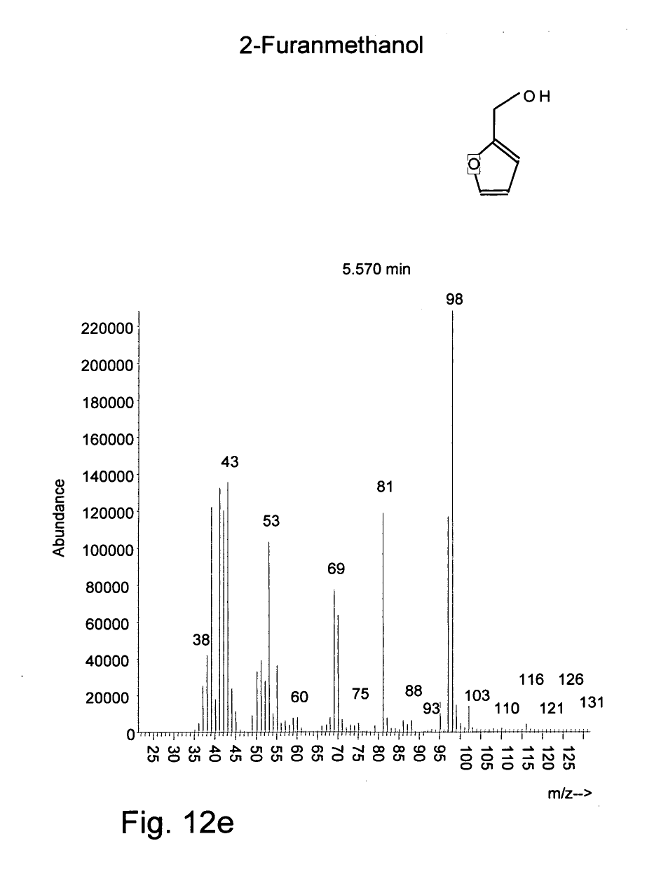

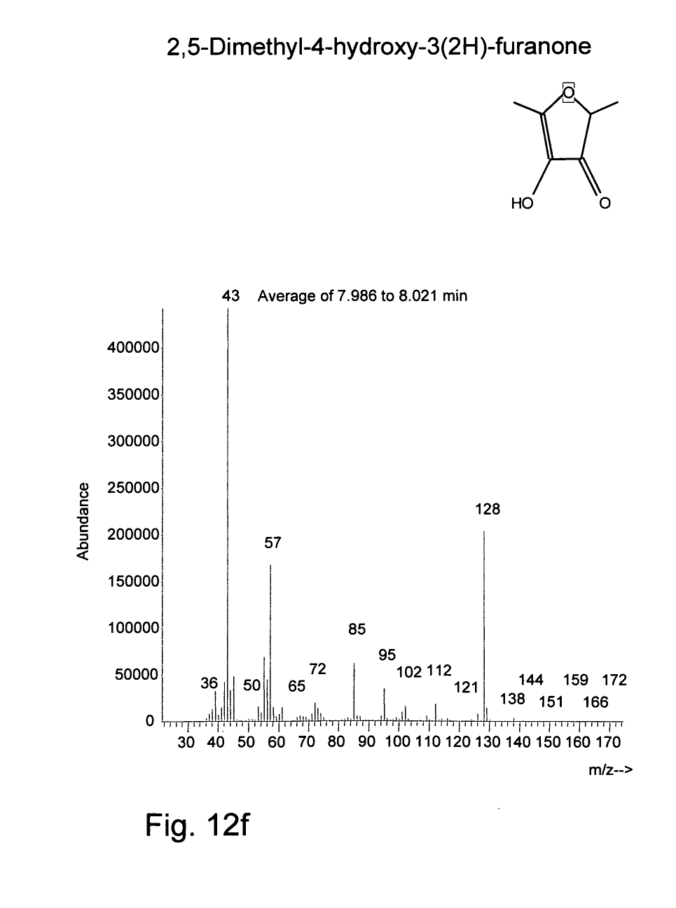

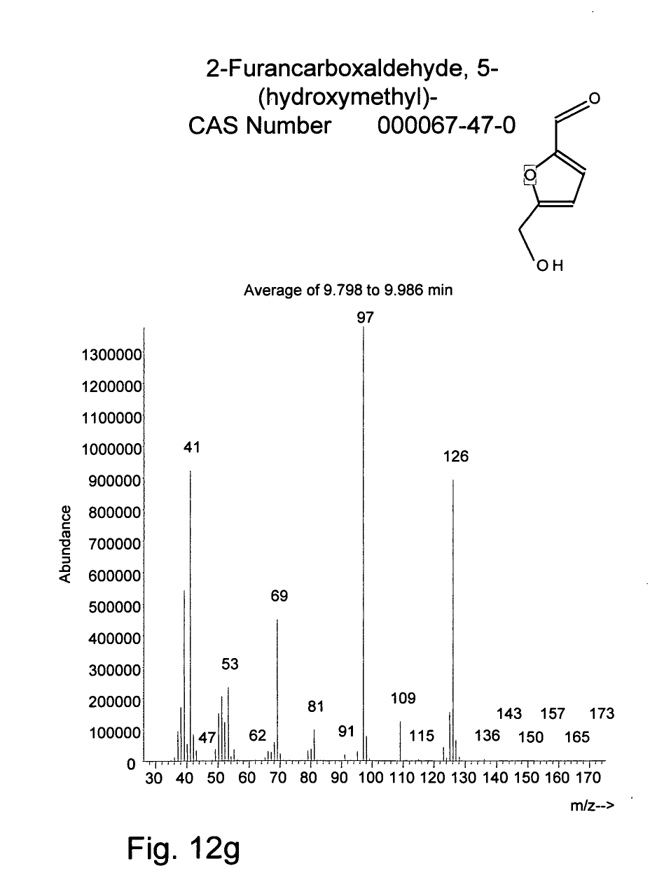

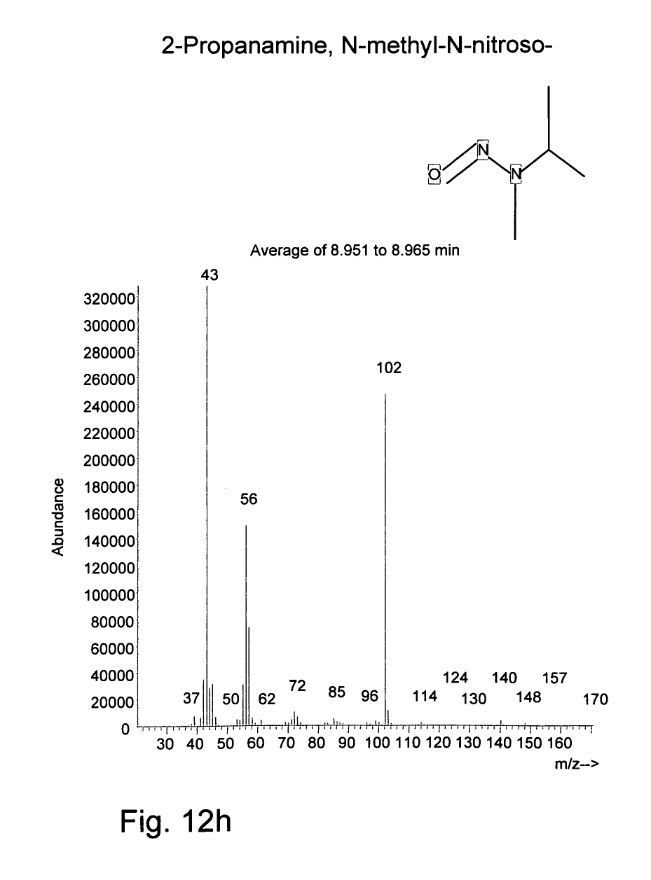

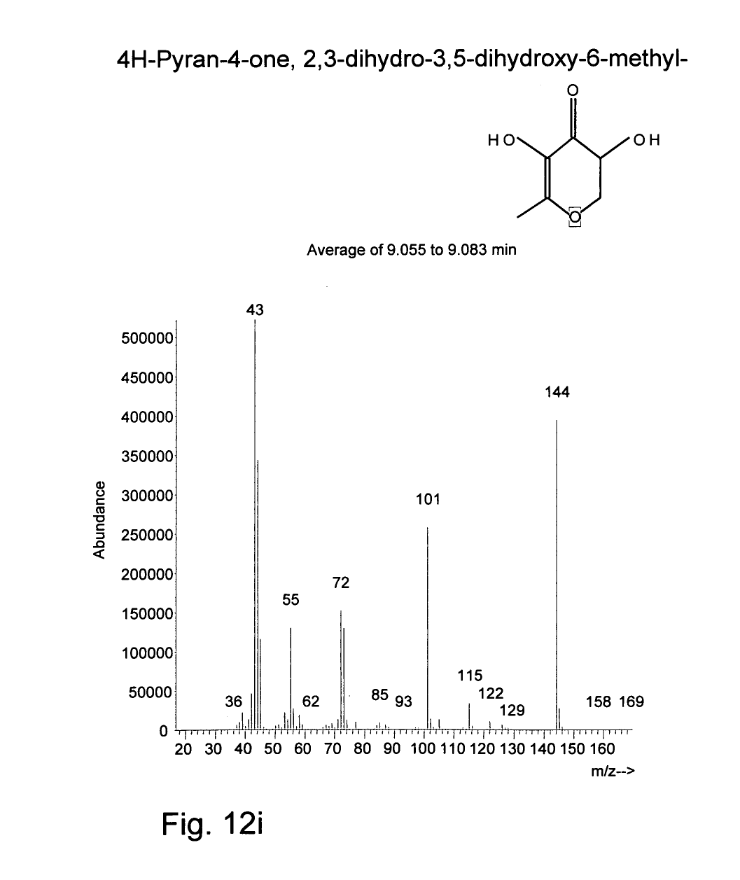

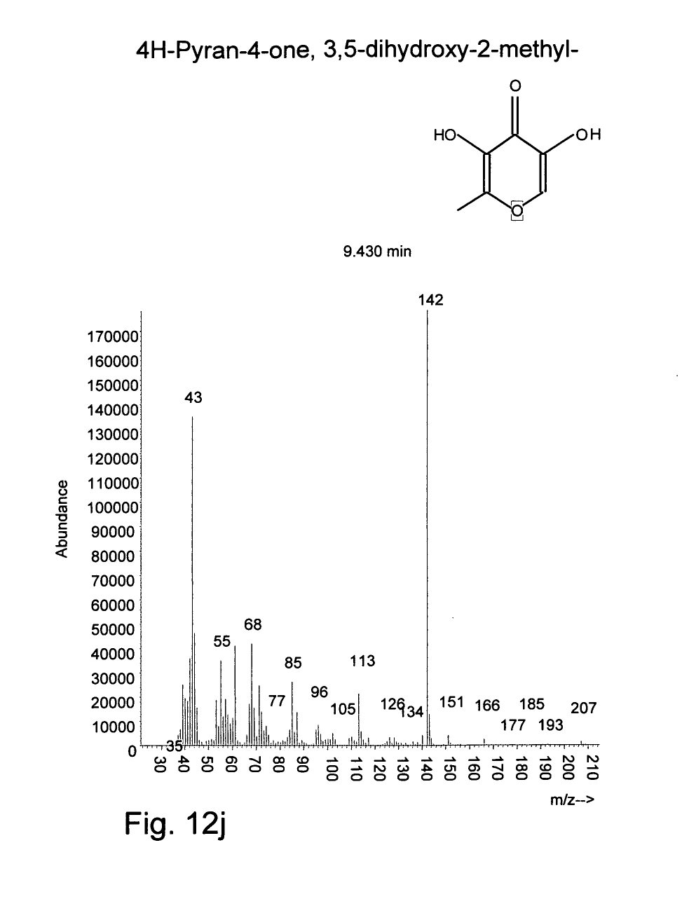

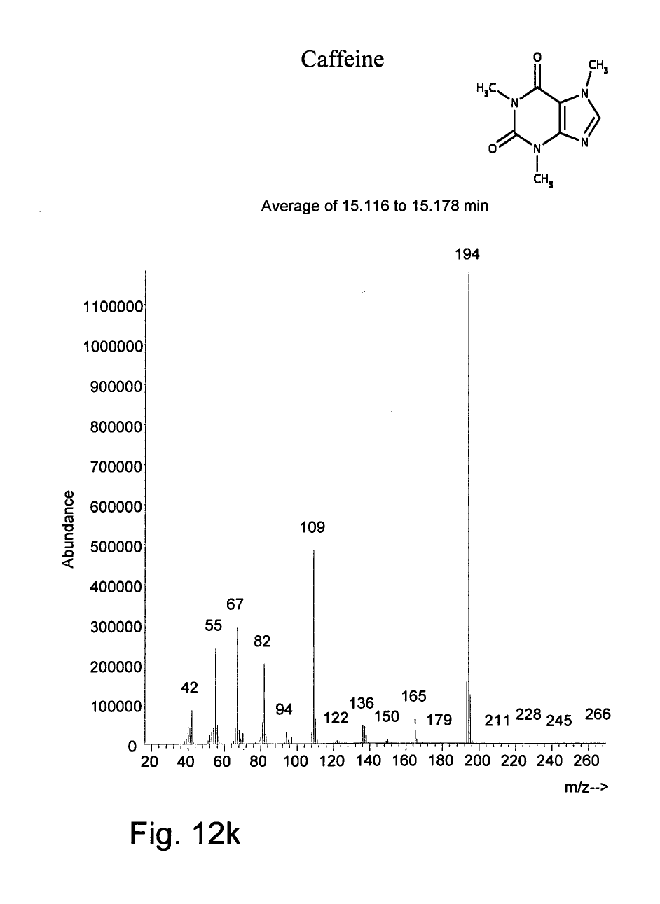

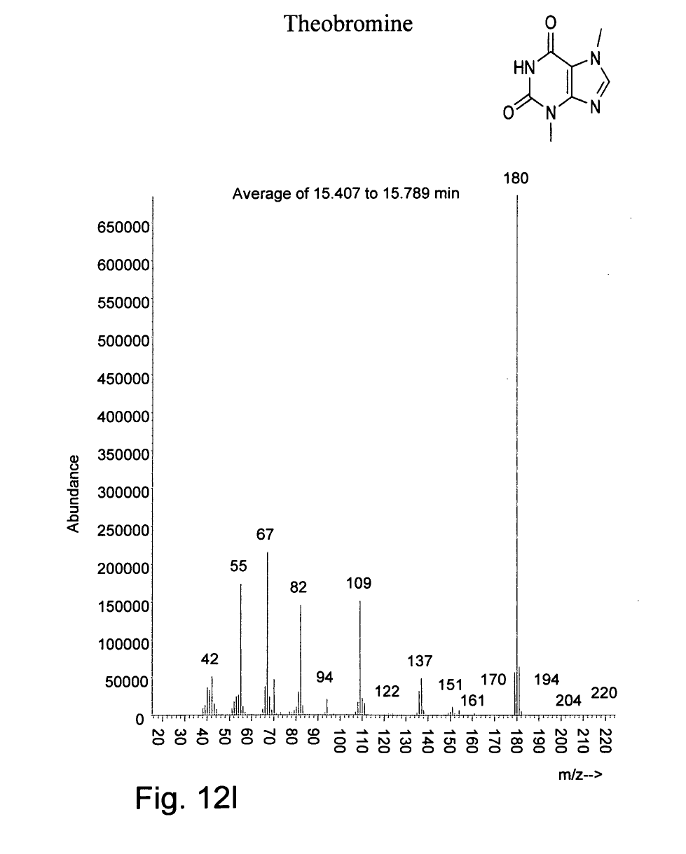

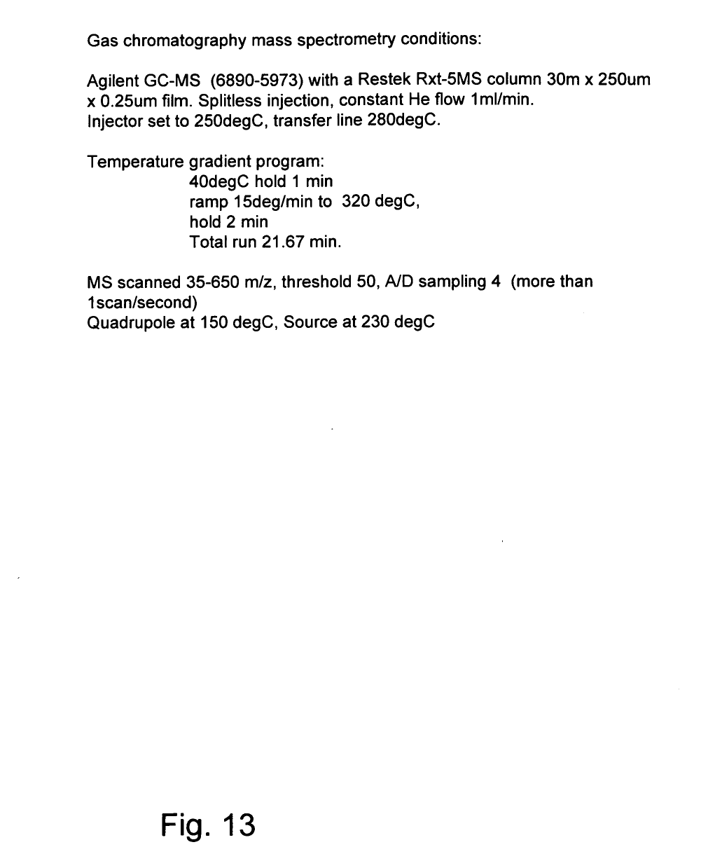

The same four key ions corresponding to theobromine, epicatechin/catechin, procyanidin and caffeine are present in cocoa powder extractions and chocolate extractions when analyzed by liquid chromatography mass spectrometry. There are small differences in retention time and concentration. Most striking is the difference in flavor profile: the chocolate extract is mild, pleasant and has a potent chocolate flavor; the cocoa powder extract has an astringent, unpleasant flavor with bitter and acrid overtones, which would need to be masked by other flavorings to make it palatable. Although the caffeine and theobromine remain essentially unchanged the procyanidin and epicatechin/catechin peaks (i.e. the antioxidants) change both in amplitude and retention time between cocoa powder extractions (FIG. 2b) and chocolate extractions (FIG. 3c). By comparing intensity (ordinate) axis scale, one can see the axis changes between the cocoa powder and the chocolate illustrating that the procyanidin and epicatechin/catechin levels are significantly reduced in the cocoa powder extract. Also, the retention times associated with procyanidin ion species in the mass spec are changed significantly suggesting there is breakdown of procyanidin and epicatechin/catechin occurring in the cocoa powder production process, and some of the complex species that have a procyanidin signature are disappearing.

The products disclosed and described herein provide the bioactive substances present in chocolate in a more absorbable form by removal of cocoa solids and cocoa butter. The effect of consuming a chocolate drink formulated in this manner is considerably more physiologically significant in contrast to the lack of significant effects of commercially available cocoa-based products. Without being bound by theory, one hypothesis for the minimal physiological benefits of current cocoa-based products is that the residual cocoa butter and/or cocoa solids in conventional cocoa comestibles impede the intestinal uptake of bioactive substances in cocoa, i.e. consumption of a cocoa drink made of the same chocolate but prepared with residual solids, or residual solids and fats, does not have the same physiological effect as the products disclosed herein. This lack of effect could be due to either chemical sequestration of bioactive chemistries into cocoa lipids/cocoa solids or an effect associated with the efficiency of adsorption in the digestive tract in response to high calorie foods. In contrast, the disclosure herein describes products having lower calories than conventional products and having lower amounts of cocoa solids and cocoa butter. The disclosure herein describes products having significantly improved benefits by having only trace amounts of residual cocoa butter and/or cocoa solids.

In an embodiment, an improved cocoa-based drink with high antioxidant content and significant bioactivity is provided. The drink has low calorific content and negligible lipid (cocoa butter) content. The drink is made using an extraction method. In an embodiment, the method involves mixing a water solution with chocolate while heating the mixture. The mixture is then cooled and subjected to centrifugal separation to separate the water phase from the oil phase and the cocoa solids phase. The phase-separated materials are segregated to recover the cocoa butter (top layer), a reddish brown aqueous layer (the extract or drink), and the depleted solids layer (the cocoa solids).

In an embodiment, the water-based extract has very low residual amounts of cocoa butter compared to conventional products that have high amounts of cocoa butter. In a further embodiment, there are no significant residual cocoa solids in the extract while such solids remain in conventional products/beverages. In a further embodiment, there are significant physiological benefits from consuming the extract in contrast to conventional cocoa beverages, which have minimal to no benefits, where the lack of benefits may be due to the existing hydraulic pressing process and residual fat content of cocoa powder reducing the activity of cocoa drinks. In a further embodiment, no purified cacao-based components are added to the extract; currently available purified cacao-based components and/or products containing such components do not appear to have significant physiological benefits.

In another embodiment, the extract is combined, or administered separately, with oral pharmaceuticals to improve uptake of the pharmaceuticals into the bloodstream. In another embodiment, the extract is combined with liquor and/or other ingredients to provide chocolate drinks containing ethyl alcohol. Cocoa drinks are often deemed undesirable because they may be perceived as fattening. More creative versions of chocolate drinks, such as chocolate martini's, are frequently unappetizing due to residual lipid in the drink, which lipid limits the amount of cocoa extract that can be consumed, e.g. highly aqueous drinks with residual significant fat content are milky looking, contain globules of fat and are difficult to stabilize. Drinks prepared using selected embodiments of the extract disclosed herein do not have the residual fat problem.

In an embodiment, a process to produce a flavorful cocoa drink absent of fat is disclosed, where the hydraulic pressing process is not used but instead a centrifugal separation scheme is used to obtain the extract. Preferably, the process uses chocolate rather than cocoa powder. The chemistry, fat content, and particle size all differ significantly between chocolate and cocoa powder. The extraction process disclosed herein is unusual and is not normally performed in making chocolate. In an embodiment, the unusual process uses water, where water is added to finished (conched) chocolate. Normally, the addition of water to chocolate is something that is absolutely avoided in conventional chocolate manufacture. In an embodiment, the chocolate does not contain emulsifiers such as lecithin, which is a common additive to many chocolates. In an embodiment, the chocolate does contain emulsifiers such as lecithin.

In an embodiment, the process to produce a chocolate extract comprises: (a) mixing chocolate chunks and water in a weight ratio of approximately one part chocolate to two parts water to form a mixture; (b) heating the mixture until the chocolate chunks are melted; (c) stirring the mixture thoroughly; (d) separating the water phase in a centrifuge; and (e) recovering the water phase to provide the extract.

Preferably, the mixture of water and chocolate is mixed thoroughly to improve the extraction efficiency. Without being bound by theory, the chocolate might undergoes a chemical reaction with the water during mixing as evidenced by a slight color change as the brown chocolate takes on a blood red hue. Since chocolate is minimally hydrated, there is the possibility of a change in chemistry upon contract with water. Preferably, the mixing process adds minimal air or oxygen. More preferably, the mixing process adds no air or oxygen.

In an embodiment, the mixture, which is a reddish material, is loaded into a high-speed centrifuge and centrifuged with cooling applied. In an embodiment, the centrifuge is run for approximately 30 minutes at a g-force of about 12,000 or higher and at a temperature of about four degrees Celsius. Preferably, only trace amounts of cocoa solids remain in the extract because cocoa-solids impede the bio-activity. The centrifuged chocolate mixture separates into three phases. The three phases are as follows: (i) a top layer of highly clarified cocoa butter; (ii) a middle layer of aqueous extracted material; and (ii) a bottom layer of cocoa solids derived from chocolate. The middle layer is the aqueous extracted material and is has a color that is brownish-reddish in hue, depending on concentration. Cooling during centrifugation assists the separation of the cocoa butter.

In an embodiment, the extract is decanted into containers/bottles for direct consumption. In an embodiment, the bottles are dark or opaque to keep out light. In an embodiment, the extract is sparged with inert gas and sealed in bottles to improve shelf stability in the final product. In an embodiment, a preservative is added to increase shelf life and to maintain freshness.

The top layer consists of clarified cocoa butter of exceptionally high quality and mild taste versus industry standard material. This higher quality is because the butter has been derived from chocolate rather than precursor materials. As such, the butter is infused with pleasant flavors and will have a slightly different chemical composition as compared to conventional cocoa butter and may confer different rheological properties to finished chocolate. This butter is re-usable for chocolate making or may be sold as a high quality cocoa butter. The bottom layer is cocoa solids, which can be broken up, dried, and reused for other purposes or merely discarded. In an embodiment, the process is used to make flavored cocoa butters since the extraction procedure and chocolate used will tend to produce different cocoa butters of extraordinary quality.

In an embodiment, chocolate chunks are mixed in an approximate ratio of one part chocolate to one part water to one part ethyl alcohol. In an alternative embodiment, chocolate chunks mixed in an approximate ratio of one part chocolate to one part water to one part gin. In an alternative embodiment, other liquors are used instead of gin, including vodka, whiskey, and rum.

In an embodiment, the mixture is heated by a water bath. In another embodiment, the mixture is heated by radiant heat. In another embodiment, the mixture is heated in a microwave oven. In an embodiment, the mixture is heated to a temperature that just melts the chocolate. In an alternative embodiment, the mixture is heated to a temperature of about 30 degrees Celsius. In an alternative embodiment, the mixture is heated to a temperature of approximately 50-95 degrees Celsius.

Without being bound by theory, embodiments of the extraction method have the advantage of permitting an aqueous extraction of substantially of the all soluble components of chocolate. Indeed, the reaction of the material with water and/or ethyl alcohol appears to liberate the bioactive moieties. Thus, not just procyanidin moieties are probably released, but a whole host of materials are probably extracted into the aqueous phase.

In an embodiment, organic solvents are used to perform the extraction instead of water or ethyl alcohol. In an embodiment, the solvent is removed by evaporation leaving the solid extracted material. This material can be reconstituted in water solution or an ethyl alcohol solution. Alternatively, this material can be packaged as a solid product as is or with a filler material, such as a cellulosic filler material improve handling ability.

Different varieties of chocolate may be used and are expected to yield different results depending on the origin of the cocoa beans, how the cocoa beans are roasted, the particle size of the chocolate, what other additives are added to the chocolate (e.g. sugar, vanilla), the conching process, the fermentation state of the cocoa beans, and percentage of non-fermented beans. In one an, the chocolate chunks have no additives such as sugar or vanilla. In an embodiment, the chocolate chunks have additives to flavor the cocoa butter obtained upon separation.

In an embodiment, products are prepared from the extract by adding bioactive moieties to the extract. The extract is expected to promote some associative uptake through the gut. Branched, adducted, or multimeric polyphenols and other bioactive moieties (once they have been separated from the cocoa solids or cocoa butter) will likely have the ability to carry other compounds into the bloodstream.

The different embodiments of the extract disclosed herein are useful as a low calorie chocolate drink, which is low in fat and high in antioxidant activity. In addition, the extract may provide the following benefits: lowered blood pressure, improved eyesight, improved color vision, improved night vision, improve sense of taste, appetite suppressant, suppression of addictive behavior, improved desire to exercise, improved athletic performance, improved endurance, shortened recovery time after exercise, reduced requirement for sleep, improved alertness, improved mood, improved transition from sleep state to waking state, improved ability to get a restful nights sleep, improved sexual desire, improved sexual performance, reduced symptoms of Raynaud's phenomenon, improved circulation to extremities, reduced stroke risk, reduced hypertension, reduced muscle pain, reduced inflammation, reduced arthritis, reduced autoimmune disorders, and/or reduced allergic responses. Finally, the extract may be useful to improve the uptake of oral delivery of drugs when co-administered.

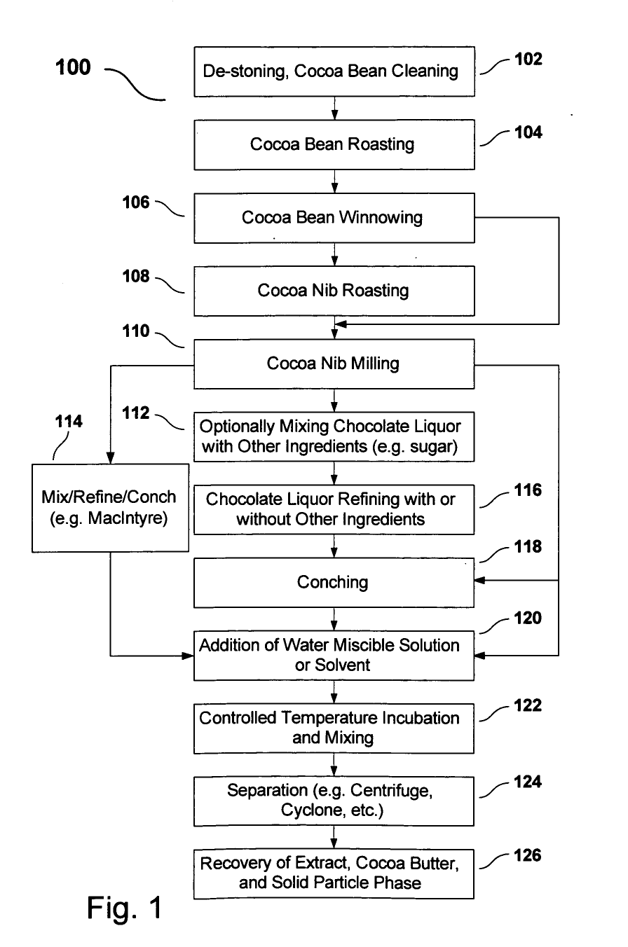

FIG. 1 provides a flow diagram 100 that shows different embodiments of the process for making a chocolate extract. The process shows part of a standard process for making chocolate, steps 102-118 or optionally steps 102-114. Steps 120-126 provide a schematic of a general process for making a chocolate extract as disclosed herein. As shown, a water miscible solution or solvent is mixed with the chocolate followed by separation and recovery of the chocolate extract.

Different combinations of mixing and separation can be used for obtaining the chocolate extract, including mixing the chocolate source and water miscible solution at different temperatures, either at the same temperature or temperature differentials between the source and solution. Various heating protocols can be used, including independent heating prior to mixing or heating after mixing. Various separation protocols can be used including immediate separation using a cooling of the mixture to improve separation or delayed separation.

In an embodiment, a process of making a chocolate extract is disclosed, comprising: (a) combining a chocolate source with a water miscible solution to form a mixture; (b) heating the mixture to melt the chocolate source to form a melted chocolate mixture; (c) mixing the melted chocolate mixture to form a slurry comprising a water miscible phase, an oil phase, and a solid particle phase; (d) separating the water miscible phase from the oil phase and the solid particle phase; and (e) recovering the water miscible phase, whereby the water miscible phase is the chocolate extract.

In an embodiment, a process of making a chocolate extract is disclosed, comprising: (a) mixing a chocolate source with a water miscible solution, wherein the water miscible solution melts the chocolate source, wherein the water miscible solution and the chocolate source form a mixture comprising a water miscible phase, an oil phase, and a solid particle phase; (b) separating the water miscible phase from the oil phase and the solid particle phase; and (c) recovering the water miscible phase, whereby the water miscible phase is the extract of chocolate.

In an embodiment, a process of making a chocolate extract is disclosed, comprising: (a) mixing a chocolate source with a water miscible solution, wherein the chocolate source is in a liquid state and the water miscible solution is at a temperature that does not solidify the chocolate source, wherein the water miscible solution and the chocolate source form a mixture comprising a water miscible phase, an oil phase, and a solid particle phase; (b) separating the water miscible phase from the oil phase and the solid particle phase; and (c) recovering the water miscible phase, whereby the water miscible phase is the extract of chocolate.

In an embodiment, chocolate extract is disclosed, where the extract has less than 1% residual cocoa solids, less than 1% residual cocoa fat, and one or more bioactive chemical species capable of lowering blood pressure after consumption of the chocolate extract. The bioactive chemical species are from an extraction process. The extraction process comprises: (a) mixing a chocolate source with a water miscible solution, wherein the water miscible solution and the chocolate source form a mixture comprising a water miscible phase, an oil phase, and a solid particle phase; (b) separating the water miscible phase from the oil phase and the solid particle phase; and (c) recovering the water miscible phase, whereby the water miscible phase is the extract of chocolate.

In an embodiment, a process of making a chocolate extract is disclosed, comprising: (a) means for mixing a chocolate source with a water miscible solution to form a mixture comprising a water miscible phase, an oil phase, and a solid particle phase; (b) means for separating the water miscible phase from the oil phase and the solid particle phase; and (c) means for recovering the water miscible phase, whereby the water miscible phase is the extract of chocolate.

The means for mixing are described throughout this description in various embodiments, including the examples and drawings, and further include mechanical agitators, sonication devices, magnetic mixing devices, and tumbling devices with or without baffles, with or without loose tumbling materials such as metal, ceramic, plastic, or other solid materials in the form of balls or another suitable shape for mixing. Examples of mixers further include: change-can mixers, kneaders, dispersers, masticators, continuous kneaders, mixer-extruders, mixing rolls, mullers, pan mixers, pugmills, pony mixers, beater mixers, internal screw mixers, and double-motion paste mixers. Combination of different mixers may be used. Any mixer suitable for mixing chocolate and water may be used.

The means for separating and recovering the water miscible phase are described throughout this description in various embodiments, including the examples and drawings, and further include gravity settling devices, centrifuges, hydrocyclones, screens, filtration, pressure filters, shell and leaf filters, cartridge filters, continuous pressure filters, pressure filter-thickener, discontinuous vacuum filters, continuous vacuum filters, rotory-drum filters, centrifugal filtration, suspended batch centrifugals, automatic batch centrifugals, continuous filtering centrifugals, flocculation, sedimentation, sorting classifiers, centrifugal decanters, tubular centrifuge, disk centrifuge, centrifugal sedimentation, nozzle-discharge centrifuge, and sludge separators. Combinations of separation devices and methods may be used. Any device suitable for separation of the water miscible phase may be used.

In an embodiment, the chocolate source is a conched chocolate. In an embodiment, the conched chocolate is a fully refined commercial chocolate. Alternatively, the chocolate source is a non-conched chocolate. In an embodiment, the unconched chocolate is a commercial chocolate. In an embodiment, the chocolate source is selected from the group consisting of unconched chocolate liquor, conched chocolate liquor, semisweet chocolate, sweet chocolate, dark chocolate, milk chocolate, baking chocolate, white chocolate, and flavored chocolate, and combinations thereof, and wherein the chocolate source is not cocoa powder or nibs. In an embodiment, the chocolate source is a liquid chocolate at room temperature. In an embodiment, chocolate source comprises approximately 1% to 100% cocoa solids.

In an embodiment, the water miscible solution is water with no additives. In an embodiment, the water miscible solution comprises up to approximately 100% ethyl alcohol. In an embodiment, the water miscible solution comprises red or white wine or spirits such as gin, whiskey, run, or vodka or a mixture of the foregoing with or without additional water and/or ethyl alcohol. In an embodiment, the water miscible solution comprises water and a salt. The salt may be sodium chloride or potassium chloride. The salt may be the salt of an organic acid. The salt may be any salt.

In an embodiment, the water miscible solution comprises water and a sweetener. The sweetener may be any mono-, di-, or tri-saccharide such as fructose, sucrose, glucose, galactose, or any combination of sugars. The sweetener may be derived from plant sources including sweeteners such as agave, stevia, or xylitol as well as corn sweeteners (corn syrup) and rice sweeteners (rice syrup) or a combination of these sweeteners and any one or more mono-, di-, or tri-saccharides. Any sweetener may be used. Suitable monosaccharides are selected from the group consisting of allose, altrose, arabinose, deoxyribose, erythrose, fructose, galactose, glucose, gulose, idose, lyxose, mannose, psicose, L-rhamnose, ribose, ribulose, sedoheptulose, D-sorbitol, sorbose, sylulose, tagatose, talose, threose, xylulose, and xylose. Suitable disaccharides are selected from the group consisting of amylose, cellobiose, lactose, maltose, melibiose, palatinose, sucrose, and trehalose. Suitable triaccharides are selected from the group consisting of raffinose and melezitose. Any combination of sweeteners and/or sugars may be used.

In an embodiment, the water solution comprises water with a mild acid. The acid may be acetic acid. Examples of other acids include: citric acid, formic acid, malic acid, lactic acid, carbonic acid, tartaric acid, gluconic acid and phosphoric acid. The acid may be a very dilute acid such as HCl or sulfuric acid.

In an embodiment, the water miscible solution comprises water with a mild base. The base may be ammonium hydroxide. The base may be a very dilute sodium hydroxide or potassium hydroxide. The base may be sodium carbonate or ammonia as well as an amine.

In an embodiment, the water miscible solution comprises water with an oxidizing agent. Examples of oxidizing agents include: Acetone, Ammonium Cerium (IV) Nitrate, Bleach, N-Bromosaccharin, N-Bromosuccinimide, N-tert-Butylbenzenesulfinimidoyl chloride, tert-Butyl hydroperoxide, tert-Butyl hypochlorite, CAN, Cerium ammonium nitrate, 3-Chloroperoxybenzoic acid, Chromium compounds, Chromium trioxide, Collins Reagent, Corey-Suggs Reagent, CMHP, Copper compounds, Cumene hydroperoxide, DBDMH, DDQ, Dess-Martin periodinane, 1,3-Dibromo-5,5-dimethylhydantoin, DIH, 1,3-Diiodo-5,5-dimethylhydantoin, 2,3-Dichloro-5,6-dicyanobenzoquinone, Dimethyl sulfoxide, Ferric Chloride, Ferric Nitrate, Formic Acid, Hydrogen peroxide, Hydrogen peroxide urea adduct, Hypervalent iodine compounds, IBX, Iodine, Iodobenzene dichloride, Iodosobenzene bis(trifluoroacetate), Iodosobenzene diacetate, N-Iodosuccinimide, Iodosylbenzene, 2-Iodoxybenzoicacid, Iron(III), (V) and (IV), Jones Reagent, Manganese compounds, Manganese(IV) oxide, MCPBA, meta-Chloroperbenzoic acid, N-Methylmorpholine-N-oxide, Methyltrioxorhenium, Molybdenum compounds, MTO, N-Bromosaccharin, N-Bromosuccinimide, N-Chlorosuccinimide, N-Iodosuccinimide, Nitric Acid, N-Methylmorpholine-N-oxide, NMO, N-tert-Butylbenzenesulfinimidoyl chloride, Osmium tetroxide, Oxalyl chloride, Oxone, Oxygen, Ozone, PCC, PDC, Peracetic acid, Periodic acid, Peroxy acids, PIFA, Pivaldehyde, Potassium ferricyanide, Potassium permanganate, Potassium peroxomonosulfate, 2-Propanone, Pyridinium hydrobromide perbromide, Pyridinium chlorochromate, Pyridinium dichromate, Pyridinium tribromide, Ruthenium(III) and (IV), Sarett Reagent, Selenium dioxide, Sodium chlorite, Sodium hypochlorite, Sodium perborate, Sodium percarbonate, Sodium periodate, Styrene, TBCA, TCCA, TEMPO, N-tert-Butylbenzenesulfinimidoyl chloride, tert-butyl hydroperoxide, tert-Butyl hypochlorite, Tetrabutylammonium peroxydisulfate, 2,2,6,6-Tetramethylpiperidinyloxy, Triacetoxyperiodinane, Tribromoisocyanuric acid, Trichloroisocyanuric acid, Trifluoroacetic peracid, Trimethylacetaldehyde, UHP, Urea hydrogen peroxide adduct, Vanadium compounds.

In an embodiment, the water miscible solution comprises water with a reducing agent. Examples of reducing agents include: Ferrous ions, Ferrous ion, Lithium aluminium hydride, Nascent hydrogen, Sodium amalgam, Sodium borohydride, Stannous ions, Sulfite compounds, Hydrazine, Oxalic acid, sulfhydryl compounds, sodium metabisulfite, sulfurous acid, and SO.sub.2-generating precursors, sulfur dioxide, L-cysteine hydrochloride, hydrogen sulfide, glutathione, cysteine, L-cysteine tartrate, and di-L-cysteine sulfite

In an embodiment, the water miscible solution comprises water with a buffer. Examples of buffers include phosphate buffers, citrate buffers, acetate buffers, borate buffers, carbonate buffers, glycine buffers, HEPES buffers, MOPS buffers, TRIS buffers, and KI solutions.

In an embodiment, separation of the mixture of the chocolate source and the water miscible solution (oil phase, water miscible phase, solid particle phase) is performed by using one or more centrifuges, or other mechanical devices. In an embodiment, the g-force greater than approximately 1,000. In an embodiment, the g-force greater than approximately 2,000. In an embodiment, the g-force is greater than approximately 8,000. In an embodiment, the g-force is greater than approximately 12,000. In an embodiment, the g-force is greater than approximately 14,000. In an embodiment, separation is performed using one or more hydrocyclones or using one or more centrifuges in combination with one or more hydrocyclones. In an embodiment, gravity settling is used. In an embodiment, the separation is performed by a device selected from the group consisting of one or more centrifuges, one or more hydrocyclones, and one or more gravity settling tanks, and combinations thereof.

In an embodiment, the melted chocolate mixture (water miscible solution and the chocolate source) is heated to a temperature greater than 30 degrees Celsius and less than 50 degrees Celsius. In an embodiment, the melted chocolate mixture (water miscible solution and the chocolate source) is heated to a temperature greater than 50 degrees Celsius and less than 100 degrees Celsius. In an embodiment, the chocolate is heated to a temperature greater than 30 degrees Celsius and then combined with the water miscible solution at a temperature greater than 30 degrees Celsius and less than 50 degrees Celsius. In an embodiment, the water is heated to a temperature of about 50 degrees Celsius and then the chocolate source is added to melt the chocolate source.

In an embodiment, a process of making a chocolate extract, comprises (a) mixing a chocolate source with a water miscible solution to form a mixture comprising a water miscible phase, an oil phase, and a solid particle phase, wherein the chocolate source is a refined and conched chocolate; and (b) recovering the water miscible phase, whereby the water miscible phase is the chocolate extract. In a further embodiment, the chocolate source is selected from the group consisting of milk chocolate, dark chocolate, baking chocolate, conched chocolate liquor, and flavored chocolate, and combinations thereof, and wherein the chocolate source is not pressed cocoa powder and not cocoa nibs. In a further embodiment, the water miscible solution is comprised of water and ethyl alcohol, wherein the amount of ethyl alcohol comprises approximately 0 to 100% of the water miscible solution. In a further embodiment, the chocolate extract has a chocolate smell and taste, and has a taste that is not bitter, sour, acrid, or astringent.

In a further embodiment, a coffee beverage is made containing the chocolate extract. In a further embodiment, an energy drink beverage is made containing the chocolate extract. In a further embodiment, a soda pop beverage is made containing the chocolate extract. In a further embodiment, a medicinal is made containing the chocolate extract.

In a further embodiment, the chocolate extract is freeze-dried to recover a powdered chocolate extract. In a further embodiment, beverages are made containing the powdered chocolate extract. In a further embodiment, medicinals are made containing the powdered chocolate. In a further embodiment, an energy bar is made containing the powdered chocolate extract.

In a further embodiment, the chocolate extract has less than approximately 1% residual cocoa solids, has less than approximately 1% residual non-polar cocoa lipids, and has one or more bioactive chemical species capable of lowering blood pressure, reducing mild to moderate back pain and muscle spasms, reducing muscle pains, acting as a vasodilator, increasing color vision, reducing desire to drink alcohol or smoke cigarettes, improve mood and disposition after consumption of the chocolate extract.

In a further embodiment, the chocolate extract comprises theobromine, epicatechin or catechin compounds, procyanidin compounds, and caffeine, wherein theobromine has a primary ion of approximately 181 m/z in an HPLC/MS spectrograph, wherein the epicatechin or catechin compounds have a primary ion of approximately 291 m/z in the HPLC/MS spectrograph, wherein the procyanidin compounds have a primary ion of approximately 579 m/z in the HPLC/MS spectrograph, wherein caffeine has a primary ion of approximately 195 m/z in the HPLC/MS spectrograph, wherein the theobromine has a retention time of approximately 3.4 to 4.3 minutes and a peak intensity of approximately 1.5×10⁶ (ion count) in an accompanying HPCL/MS spectrograph, wherein the epicatechin or catechin compounds have a retention time of approximately 13.5 to 14.3 minutes and a peak intensity of approximately 4.5×10⁵ (ion count) for a first peak and optionally have a second peak with a retention time of 7.8 to 8.3 minutes in the accompanying HPLC/MS spectrograph, wherein the procyanidin compounds have a retention time of approximately 10.7 to 11.7 minutes and a peak intensity of approximately 5×10⁵ (ion count) for a first peak and optionally have a second peak with a retention time of 13.3 to 18.5 minutes and optionally have a third peak with a retention time of approximately 5.8 to 6.8 minutes and optionally have a fourth peak with a retention time of approximately 8.1 to 8.3 minutes in the accompanying HPCL/MS spectrograph, and wherein the caffeine has a retention time of approximately 10.7 to 11.7 minutes and a peak intensity of approximately 6×10⁵ (ion count) in the accompanying HPCL/MS spectrograph.

### Example 1

In this example, 70 grams of melted Theo's Dark Chocolate were added to 185 mL of tap water without additives. The temperature of the melted chocolate was between 30 and 40 degrees Celsius when added to the water. The mixture of chocolate and water was then heated to ensure that the chocolate was melted while in the water. After heating the mixture, the final temperature of the mixture was approximately 38 degrees Celsius. The mixture was agitated using a mechanical laboratory mixer for one hour at a speed to maintain a vortex while not allowing the mixture to splash out of the side of the container. After agitation, the mixture had changed color from brown to a reddish brown color. The mixture was then loaded into a high-speed centrifuge and centrifuged with gentle cooling applied. The run time was approximately 12 minutes at 16,000 g at 10 degrees Celsius. The centrifuged mixture separated into three phases: cocoa butter (top), extract (middle), cocoa solids (bottom). After centrifuging and being cooled to a temperature of 10 degrees Celsius, the container was placed into a refrigerator to further cool the component phases. The three layers were: a solid top layer of highly clarified cocoa butter; a middle layer of aqueous extracted material in quantity very close to input volume; and a bottom layer of cocoa solids derived from chocolate.

The middle layer, the aqueous extracted material, was a reddish brown in color. This material was decanted into bottles for testing. The top layer consisted of clarified cocoa butter of exceptionally high quality and mild taste versus industry standard material. This is because it was derived from chocolate rather than precursor materials. As such, it was infused with pleasant flavors and had a slightly different chemical composition to conventional cocoa butter. The bottom layer appeared to be cocoa solids with moisture therein.

### Example 2

In this example, 70 grams of Theo's Dark Chocolate were broken apart and added to 92.5 grams of tap water and 92.5 grams of gin. All other conditions were the same as in Example 1. The final extract had the taste of a mild chocolate drink with gin added thereto.

### Example 2

In this example, 80 grams of melted (30 degrees Celsius) Theo's Dark Chocolate was added to 175 mL of tap water and 1.25 mL glycerin. The mixture was incubated at 38 degrees Celsius for 1.5 hours with periodic agitation. All other conditions were the same as in Example 1. The final extract had a taste of a mild chocolate drink.

### Example 3

In this example, 70 grams of molten (30 degrees Celsius) Theo's Dark Chocolate is added to 179 mL water, 1.25 mL of glycerin, and 5 mL of gin. The mixture is incubated for 24 hours at 30 degrees Celsius with periodic agitation. The mixture is sonicated for three minutes using a probe sonicator. All other conditions are the same as in Example 1.

### Example 4

In this example, 80 grams of molten Theo's Dark Chocolate (30 degrees Celsius) is added to 175 mL of red wine. The mixture is incubated for 24 hours at 25 degrees Celsius with agitation. All other conditions are the same as in Example 1.

### Example 5

In this example, one part melted Dark Chocolate at 35 degrees Celsius is combined with three parts of aqueous-based solvent using an inline mixing manifold with a heating jacket at 35 degrees C. The mixture is piped into a centrifugal separator at 12,000 g. The centrifugal separator separates the solid and the two liquid phases of the incubated chocolate. Separation occurs in a single process, i.e. liquid-liquid-solid separation. The two liquid phases are removed and further separated in a holding tank by cooling to solidify the cocoa butter. The aqueous-based extract is recovered, and the cocoa butter is further processed. The cocoa solids are deposited into a separate container.

### Example 6

In this example, one part melted Dark Chocolate at 35 degrees Celsius is combined with three parts of aqueous-based solvent using an inline mixing manifold with a heating jacket at 35 degrees C. The mixture is piped into a centrifugal separator at 12,000 g. The centrifugal separator separates the solid and the two liquid phases of the incubated chocolate. Separation occurs in a single process, i.e. solid-liquid-solid separation. The liquid phase is removed to recover the chocolate extract. The cocoa butter is removed and is further processed. The cocoa solids are deposited into a separate container.

### Example 7

In this example, one part melted Dark Chocolate at 35 degrees Celsius is combined with three parts of aqueous solvent using an inline mixing manifold with a heating jacket at 35 degrees C. The mixture is piped into a centrifugal separator at 12,000 g. The centrifugal separator separates the solid and the two liquid phases of the incubated chocolate. Separation occurs in a single process, i.e. liquid-liquid-solid. The two-phase liquid mixture is deposited into a temperature controlled holding tank where separation of the cocoa butter and aqueous phase occurs by gravity, cooling, and heating, as needed. The two liquids are then filtered and separated. The cocoa solids are deposited into a separate container.

### Example 8

In this example, one part melted Dark Chocolate at 35 degrees Celsius is combined with three parts of aqueous-based solvent using an inline mixing manifold with a heating jacket at 35 degrees C. The mixture is piped into a centrifugal separator at 12,000 g. The centrifugal separator separates the solid and the two liquid phases of the incubated chocolate. Separation occurs in a single process, i.e. liquid-liquid-solid separation. Each liquid phase is removed independently, and each is further separated by cooling to solidify the cocoa butter as need. The aqueous-based extract is recovered, and the cocoa butter is further processed, if needed, to purify the butter. The cocoa solids are deposited into a separate container.

### Example 9

70% dark chocolate was made by roasting fermented cocoa beans from Theobroma Cacao from Panamanian or Dominican Republic origin. Roasted cocoa beans were de-shelled (winnowed) and the resulting cocoa nibs were roasted a second time to develop flavor. Roasted nibs were ground using a stone mill and a ball mill and the resultant chocolate liquor was blended with an equal quantity of evaporated cane juice (sugar). The sugar/liquor slurry was refined using a 3 roll pre-refiner and 5 roll finish-refiner and the resulting material combined with additional liquor to yield a final ratio of 7 parts liquor to 3 parts sugar. This mixture was then mixed and heated in a Petzhold conch for 48 hours under high shear conditions. A temperature spike of 83 degrees centigrade was applied in the early phase of conching and the conch allowed to cool to 65 centigrade. Conched chocolate was tempered using a Sollich Tempering machine and molded into 85 gram bars.

920 grams of chocolate bars were heated to 50 degrees centigrade by microwave irradiation, 0.1% by weight ground vanilla bean was added the molten mixture combined with a room-temperature mixture of diluted alcohol comprising 1836 grams water and 564 grams of 96% ethanol. The mixture was incubated for three hours at a temperature of 45 degrees centigrade with occasional stirring. The mixture was then distributed equally between six 220 ml centrifuge bottles and centrifuged at 12,000 g for 20 minutes in a Sorvall R C-26 centrifuge. The centrifuge rotor was initially at room temperature and the chamber cooled to 6 degrees centigrade during the run. Centrifugal separation yielded three layers consisting of 2339 grams of eluate, 335 grams of cocoa butter and 646 grams of cocoa powder slurry. The cocoa butter was further processed by heating to 105 degrees centigrade to remove residual solvent and the cocoa powder slurry was oven dried. The alcoholic eluate was consumed as is. Testing of the alcoholic eluate by the Oxygen Radical Absorbance Capacity (ORAC) Assay indicated that the eluate contained greater than 45 Trolox equivalents (TE) units per milliliter (ml) of eluate.

Consumption of 100 ml of alcoholic chocolate eluate was attempted after mild to moderate back pain and skeletal muscle fatigue brought about by physical over exertion on six separate occasions with two separate individuals (middle aged males). The consumption of the alcoholic chocolate eluate resulted in a decline in acute discomfort with 2 hours and resumption of normal gait and posture within 6-12 hours. Consumption of an equal quantity of dilute ethanol did not produce the same effect.

### Example 10

In this example, alcoholic eluate containing 14.9% solids with a pH of 5.2 was dried by a freeze-drying process. 400 grams of eluate was diluted with 400 grams of purified water and poured into a Lyogaurd tray. The tray and contents was cooled to −40 degrees C. and subjected to a low oxygen atmosphere and vacuum pressure of <200 microns. The tray was cycled through a series of warming and cooling cycles from −10 degrees centigrade to −30 degrees centigrade over a 33 hour period. The freeze-drying process resulted in a pleasant, sweet chocolate smelling friable slab of brown cake-like material with striations weighing a total of 78 grams (dry weight). The slab was broken up and the powder was consumed either as an ingredient in an energy bar or as an alcohol-free powder which was reconstituted in room temperature water as an energy drink. In both cases the resulting powder was reconstituted to sweet chocolate flavored comestibles. The energy bar consisted of sugar, oatsc and chopped mixed nuts with 5 grams of freeze dried chocolate extract. The energy drink consisted of water, 5 grams of freeze dried extract, and natural flavorings, including vanilla. The freeze dried chocolate extract had a pleasant, non-astringent flavor. Consumption of the freeze dried extract resulted in a measurable lowering of blood pressure, of 3-6 mm Hg (SD +/−4 mm Hg), symptom improvement after muscle strain, and a general feeling of energy and well-being.

### Example 11

In this example, more than 50 mls of a 25% alcoholic eluate (the production of which is described in example 9) was consumed after 2 pints of beer. Consumption of the alcoholic eluate led to a decreased desire to consume additional alcohol or smoke cigarettes within 30 minutes of consumption. Consumption of an equal concentration of alcohol in non-chocolate containing beverages did not result in this effect, rather the consumption of alcohol tended to result in the consumption of more alcohol, cigarettes and an overall depressive effect on the central nervous system. In contrast, consumption of the chocolate containing alcoholic eluate produced an anti-depressant like effect characterized by a positive disposition and increased mental activity, reduced tiredness, apparent increased mental acuity and, in certain individuals, an increase in perceived color vision.

### Example 12

In this example, cocoa powder was extracted using a mixture of water and ethyl alcohol, 25% alcohol. The resulting drink recovered therefrom had an unpleasant smell and tasted sour and medicinal.

The various embodiments disclosed herein of the processes for making the chocolate extract and the extract itself include any combination of the other various embodiments disclosed herein applicable to the elements and limitations of said processes and extract, including those of the examples and drawings.

What is claimed is:

1. A process of making a chocolate extract, comprising:
(a) mixing a chocolate source with a water miscible solution to form a mixture comprising a water miscible phase, an oil phase, and a solid particle phase, wherein the chocolate source is a conched chocolate; and
(b) recovering the water miscible phase, whereby the water miscible phase is the chocolate extract.

2. The process of claim 1, wherein the chocolate source is selected from the group consisting of unconched chocolate liquor, conched chocolate liquor, semisweet chocolate, sweet chocolate, dark chocolate, milk chocolate, baking chocolate, and flavored chocolate, and combinations thereof, and wherein the chocolate source is not cocoa powder or nibs.

3. The process of claim 1, wherein the water miscible solution is comprised of water and ethyl alcohol, wherein the amount of ethyl alcohol comprises approximately 0 to 100% of the water miscible solution.

4. A chocolate extract made by the process of claim 1, wherein the chocolate extract has polyphenols, has a chocolate smell and taste, and has a taste that is not bitter, sour, acrid, or astringent.

5. The process of claim 1, further comprising: (c) freeze-drying the chocolate extract, whereby a powdered chocolate extract is recovered.

6. A chocolate extract made by the process of claim 1, wherein the chocolate extract has less than approximately 1% residual cocoa solids, has less than approximately 1% residual non-polar cocoa lipids, and has one or more bioactive chemical species, wherein the bioactive chemical species are present in the chocolate extract as a result of the process of claim 1.

7. The process of claim 1, further comprising: (c) administering the chocolate extract orally to lower blood pressure, reduce back pain, reduce muscle spasms or pain, act as a vasodilator, increase color vision, reduce desire to drink alcohol, reducing desire to smoke cigarettes, or improving mood.

8. A chocolate extract comprising: theobromine, epicatechin or catechin compounds, procyanidin compounds, and caffeine, wherein theobromine has a primary ion of approximately 181 m/z in an HPLC/MS spectrograph, wherein the picatechin or catechin compounds have a primary ion of approximately 291 m/z in the HPLC/MS spectrograph, wherein the procyanidin compounds have a primary ion of approximately 579 m/z in the HPLC/MS spectrograph, wherein caffeine has a primary ion of approximately 195 m/z in the HPLC/MS spectrograph, wherein the theobromine has a retention time of approximately 3.4 to 4.3 minutes and a peak intensity of approximately 1.5×10⁶ (ion count) in an accompanying HPCL/MS spectrograph, wherein the epicatechin or catechin compounds have a retention time of approximately 13.5 to 14.3 minutes and, a peak intensity of approximately 4.5×10⁵ (ion count) for a first peak and optionally have a second peak with a retention time of 7.8 to 8.3 minutes in the accompanying HPLC/MS spectrograph, wherein the procyanidin compounds have a retention time of approximately 10.7 to 11.7 minutes and a peak intensity of approximately 5×10⁵ (ion count) for a first peak and optionally have a second peak with a retention time of 13.3 to 18.5 minutes and optionally have a third peak with a retention time of approximately 5.8 to 6.8 minutes and optionally have a fourth peak with a retention time of approximately 8.1 to 8.3 minutes in the accompanying HPCL/MS spectrograph, and wherein the caffeine has a retention time of approximately 10.7 to 11.7 minutes and a peak intensity of approximately 6×10⁵ (ion count) in the accompanying HPCL/MS spectrograph.
